(19) United States
(12) Patent Application Publication
(10) Pub. No.: US 2017/0289533 A1
(43) Pub. Date: Oct. 5, 2017

(54) HEAD MOUNTED DISPLAY, CONTROL METHOD THEREOF, AND COMPUTER PROGRAM

(71) Applicant: SEIKO EPSON CORPORATION, Tokyo (JP)

(72) Inventor: Takehiro ONO, Chino-shi (JP)

(73) Assignee: SEIKO EPSON CORPORATION, Tokyo (JP)

(21) Appl. No.: 15/466,089

(22) Filed: Mar. 22, 2017

(30) Foreign Application Priority Data
Mar. 30, 2016 (JP) 2016-068133
Oct. 20, 2016 (JP) 2016-205591

(51) Int. Cl. H04N 13/04; G02B 27/01; G06T 19/20; G06F 3/01; G06T 19/00; G06T 17/10

(52) U.S. Cl. CPC H04N 13/0497; H04N 13/044; G06T 19/006; G06T 17/10; G06T 19/20; G06F 3/016; G06F 3/011; G02B 27/017; G06T 2219/2016; G06T 2200/24; G06T 2200/04; G02B 2027/014; G02B 2027/0141; G02B 2027/0134; G02B 2027/0178

(57) ABSTRACT

A head mounted display includes a display unit that displays an image, and a processor that executes a process. The processor includes a polyhedron image display unit that displays a polyhedron image in which an instruction to instruct the process is allocated to each surface of the polyhedron, on the display unit, a polyhedron orientation switching unit that receives an operation on the polyhedron image, and switches the orientation in which the polyhedron is displayed, and an instruction execution unit that executes the instruction allocated to a surface of a predetermined orientation in the polyhedron image.

### BACKGROUND

1. Technical Field

The present invention relates to a head mounted display, a control method of a head mounted display, and a computer program.

2. Related Art

In recent years, a head mounted display is spreading which can display an image in front of the eye of a user. A head mounted display in the related art includes a controller having a touch pad, in addition to the eyeglasses portion worn on the head, and acquires commands (instructions) from the user by using the controller. Specifically, a button and a cursor are displayed on the eyeglasses portion, the cursor is moved on the button by the touch pad, and an operation for tapping is received, whereby inputting an instruction set in the button.

The operation of moving the cursor over the button and tapping is troublesome. Thus, a configuration in which a button can be tapped with a hand presented in a see-through display area is described in JP-A-2015-519673.

JP-A-2013-542514 is another example of the related art.

However, in the head mounted display described in JP-A-2015-519673, for example, even in a configuration in which the button can be tapped by hand, it is necessary to accurately hit the fingertip on the button, and to select a desired button from among many buttons, such that the operability cannot be improved sufficiently. In addition, in the head mounted display in the related art, it has been desired to improve the search accuracy, make the device configuration compact, reduce the cost, conserve resources, make manufacturing easier, and the like.

### SUMMARY

An advantage of some aspects of the invention is to solve at least a part of the problems described above, and the invention can be implemented as the following aspects.

(1) According to an aspect of the invention, a head mounted display is provided. The head mounted display includes a display unit that displays an image, and a processor that executes a process. The processor includes a polyhedron image display unit that displays a polyhedron image in which an instruction to instruct the process is allocated to each surface of the polyhedron, on the display unit, a polyhedron orientation switching unit that receives an operation on the polyhedron image, and switches the orientation in which the polyhedron is displayed, and an instruction execution unit that executes the instruction allocated to a surface of a predetermined orientation in the polyhedron image. According to the head mounted display of this aspect, since the operation on the polyhedron image is received, the orientation of the polyhedron is switched by the polyhedron orientation switching unit, and the instruction allocated to a surface of a predetermined orientation in the polyhedron image is executed by the instruction execution unit. Therefore, the user of the head mounted display can perform a process related to an image, only by performing the operation on the polyhedron image. Thus, the head mounted display of this aspect is able to improve the operability of the user.

(2) In the head mounted display of the aspect, the display unit may be configured to allow an outside scene to be viewed, and the processor may display a related image related to the outside scene to be viewed, on the display unit, and execute a process based on the related image. According to the head mounted display of this aspect, the user can perform the process related to the outside scene which can be viewed by the display unit.

(3) In the head mounted display of the aspect, the related image may include identification information for identifying a plurality of stores included in the outside scene to be viewed, and the process executed by the processor may be a store input process for designating one store from the plurality of stores. According to the head mounted display of this aspect, the process for designating one store from the plurality of stores included in the outside scene to be viewed can be performed with a good operability.

(4) In the head mounted display of the aspect, the related image may include a support image for supporting a work related to the outside scene to be viewed, and the process executed by the processor may be a process for sequentially switching the support image. According to the head mounted display of this aspect, the process for sequentially switching the support image for a work related to the outside scene to be viewed can be performed with a good operability.

(5) In the head mounted display of the aspect, the polyhedron image may be a regular hexahedron 3D image, and the surface in the pre-determined orientation may be a surface facing the user. According to the head mounted display of this aspect, the user can perform a process by an easy and intuitive operation such as rotating a regular hexahedron. Accordingly, the operability can be further improved.

(6) In the head mounted display of the aspect, the operation on the polyhedron image may be a flick operation with a fingertip. According to the head mounted display of this aspect, the user can perform the process only by performing a simple operation such as a flick. Accordingly, the operability can be further improved.

(7) The head mounted display of the aspect may further include an operation unit provided with an input unit for receiving an input operation by a user on a first surface of a plurality of surfaces forming the outside, and the polyhedron orientation switching unit may detect an operation of switching the orientation of the first surface in the operation unit, and receive the detected operation of switching the orientation of the first surface as an operation on the polyhedron image. According to the head mounted display of this aspect, the user can perform the process only by performing a simple operation such as switching the orientation of the operation unit. Accordingly, the operability can be further improved.

(8) The head mounted display of the aspect may further include an object with a polyhedron shape corresponding to the polyhedron image, and the polyhedron orientation switching unit may detect an operation of switching the orientation of the object, and receive the detected operation of switching the orientation of the object as an operation on the polyhedron image. According to the head mounted display of this aspect, the user can perform the process only by performing a simple operation such as switching the orientation of an object with a polyhedron shape corresponding to a polyhedron image. Accordingly, the operability can be further improved.

(9) The head mounted display of the aspect may further include a vibration unit that vibrates when receiving the operation on the polyhedron image. According to the head mounted display of this aspect, it is possible to notify the user of the reception of the operation on the polyhedron image by vibration. Therefore, the user can feel with the skin that the operation on the polyhedron image is received, and the operability can be further improved.

(10) According to another aspect of the invention, a head mounted display is provided. The head mounted display includes a display controller that displays an image, and a processor that executes a process. The processor includes a stereoscopic image display unit that displays a stereoscopic image in which an instruction to instruct the process is allocated to each surface of a solid, on the display unit, a solid orientation switching unit that receives an operation on the stereoscopic image, and switches the orientation in which the solid is displayed, and an instruction execution unit that executes the instruction allocated to a surface of a predetermined orientation in the stereoscopic image. According to the head mounted display of this aspect, since the operation on the stereoscopic image is received, the orientation of the solid is switched by the solid orientation switching unit, and the instruction allocated to a surface of a predetermined orientation in the stereoscopic image is executed by the instruction execution unit. Therefore, the user of the head mounted display can perform a process related to an image, only by performing the operation on the stereoscopic image. Thus, the head mounted display of this aspect is able to improve the operability of the user.

The invention can be implemented in various forms other than the head mounted display. For example, the invention can be implemented by a control method of a head mounted display, a computer program for realizing the function of each constituent element of the head mounted display, a recording medium on which the computer program is recorded, or the like.

### BRIEF DESCRIPTION OF THE DRAWINGS

The invention will be described with reference to the accompanying drawings, wherein like numbers reference like elements.

FIG. 1 is an explanatory diagram illustrating a schematic configuration of an information processing system of a first embodiment of the invention.

FIG. 2 is a plan view of a main part illustrating a configuration of an optical system included in an image display unit.

FIG. 3 is a diagram illustrating a configuration of main parts of the image display unit viewed from a user.

FIG. 4 is a diagram illustrating an angle of view of a camera.

FIG. 5 is a block diagram functionally illustrating a configuration of a HMD.

FIG. 6 is a block diagram functionally illustrating a configuration of a control device.

FIG. 7 is an explanatory diagram illustrating an example of augmented reality display by the HMD.

FIG. 8 is a block diagram functionally illustrating a configuration of a store server.

FIG. 9 is a flowchart illustrating a store input processing routine.

FIG. 10 is an explanatory diagram illustrating a data set transmitted from the store server to the HMD.

FIG. 11 is an explanatory diagram illustrating an example of the user's field of view after a process of step S160 is executed.

FIG. 12 is an explanatory diagram illustrating an example of an operation of rotating a cubic switch.

FIG. 13 is an explanatory diagram illustrating the cubic switch after rotation.

FIG. 14 is an explanatory diagram illustrating a see-through display area and an interface area, which are generated by a work support processor of a second embodiment.

FIG. 15 is an explanatory diagram illustrating a modification example of the switch.

FIG. 16 is an explanatory diagram illustrating a modification example of the switch.

FIG. 17 is an explanatory diagram illustrating a modification example of the cubic switch.

FIG. 18 is an explanatory diagram illustrating a controller in a third embodiment.

FIG. 19 is an explanatory diagram when a surface of the controller is directed to a left side.

FIG. 20 is an explanatory diagram when the surface of the controller is directed to a right side.

FIG. 21 is an explanatory diagram when the surface of the controller is directed downward.

FIG. 22 is a perspective view illustrating a second controller in a fourth embodiment.

FIG. 23 is an explanatory diagram illustrating a watch-type device in a fifth embodiment.

FIG. 24 is a plan view of a main part illustrating a configuration of an optical system included in an image display unit of a modification example.

### DESCRIPTION OF EXEMPLARY EMBODIMENTS

### A. First Embodiment

### A-1. Entire Configuration of Information Processing System

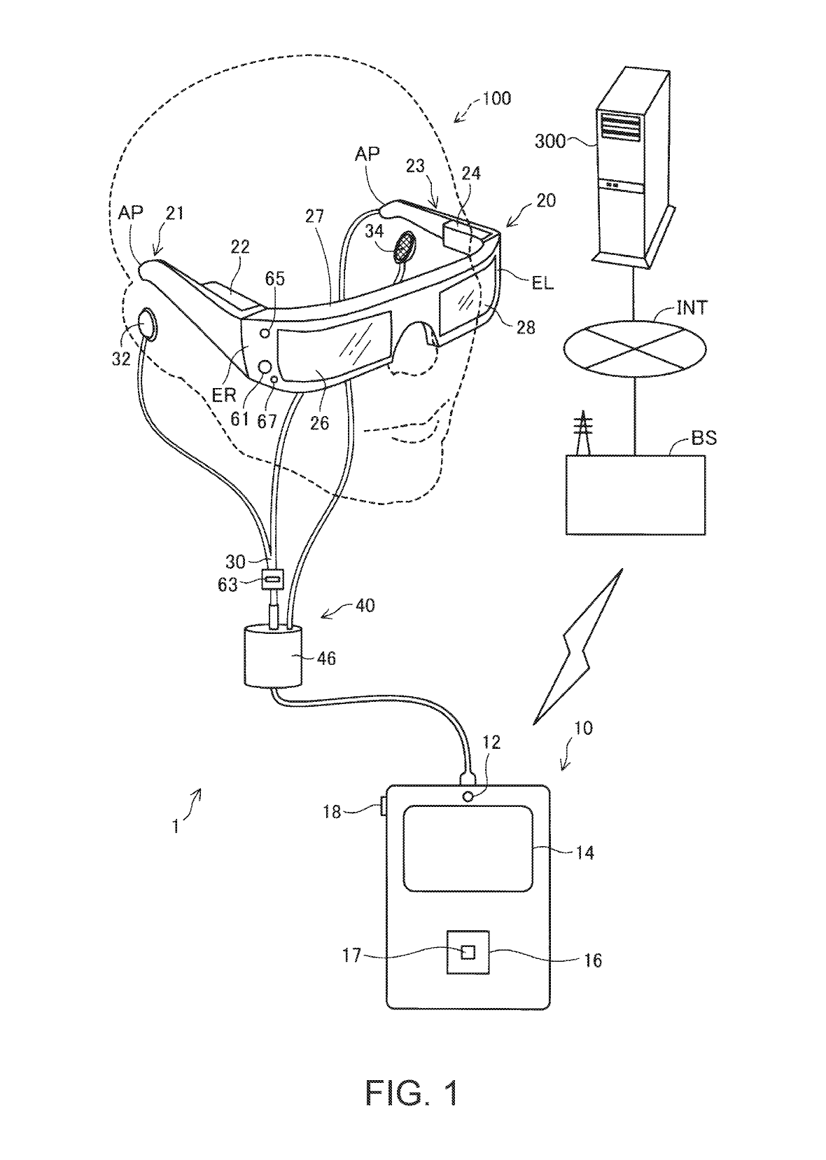

FIG. 1 is an explanatory diagram illustrating a schematic configuration of an information processing system of a first embodiment of the invention. An information processing system 1 includes a head mounted display 100 and a store server 300. The head mounted display 100 is connected to the Internet INT by wireless communication through a communication carrier BS. The store server 300 is connected to the Internet INT through wired communication. As a result, the head mounted display 100 and the store server 300 are connected to each other through the Internet INT. The communication carrier BS includes a transmission/reception antenna, a wireless base station, and an exchange station.

The head mounted display 100 searches for a store database (to be described later) accumulated in the store server 300. The details of the head mounted display 100 and the store server 300 will be described later.

### A-2. Configuration of Head Mounted Display

The head mounted display 100 is a display device mounted on the user's head, and also referred to as HMD. The HMD 100 is a see-through type (a transmissive type) head mounted display in which an image appears in the outside world viewed through a glass.

The HMD 100 includes an image display unit 20 that allows the user to view an image, and a control device (controller) 10 that controls the image display unit 20.

The image display unit 20 is a wearing object to be worn on the head of the user, and has a spectacle shape in the present embodiment. The image display unit 20 includes a right display unit 22, a left display unit 24, a right light guide plate 26, and a left light guide plate 28, in a body having a right holding unit 21, a left holding unit 23, and a front frame 27.

The right holding unit 21 and the left holding unit 23 respectively extend rearward from both ends of the front frame 27, and hold the image display unit 20 on the head of the user like a temple of glasses. Among the both end portions of the front frame 27, the end portion located on the right side of the user in the state of wearing the image display unit 20 is referred to as the end portion ER, and the end portion located on the left side of the user is referred to as the end portion EL. The right holding unit 21 extends from the end ER of the front frame 27 to a position corresponding to the right lateral head of the user in the state of wearing the image display unit 20. The left holding unit 23 extends from the end EL of the front frame 27 to a position corresponding to the left lateral head of the user in the state of wearing the image display unit 20.

The right light guide plate 26 and the left light guide plate 28 are provided on the front frame 27. The right light guide plate 26 is located in front of the user's right eye in the state of wearing the image display unit 20, and causes the right eye to view an image. The left light guide plate 28 is located in front of the user's left eye in the state of wearing the image display unit 20, and causes the left eye to view an image.

The front frame 27 has a shape in which one end of the right light guide plate 26 and one end of the left light guide plate 28 are connected to each other. The connection position corresponds to the position of the middle of the forehead of the user in the state of wearing the image display unit 20. A nose pad contacting the user's nose may be provided in the front frame 27 in the state of wearing the image display unit 20, at the connection position between the right light guide plate 26 and the left light guide plate 28. In this case, the image display unit 20 can be held on the head of the user by the nose pad, the right holding unit 21, and the left holding unit 23. A belt that contacts the back of the user's head may be connected to the right holding unit 21 and the left holding unit 23 in the state of wearing the image display unit 20. In this case, the image display unit 20 can be firmly held on the user's head by the belt.

The right display unit 22 displays an image by the right light guide plate 26. The right display unit 22 is provided in the right holding unit 21, and is located in the vicinity of the right lateral head of the user in the state of wearing the image display unit 20. The left display unit 24 displays an image by the left light guide plate 28. The left display unit 24 is provided in the left holding unit 23, and is located in the vicinity of the left lateral head of the user in the state of wearing the image display unit 20. The right display unit 22 and the left display unit 24 are collectively referred to as a “display driving unit”.

The right light guide plate 26 and the left light guide plate 28 of this embodiment are optical units (for example, prisms) made of a light transmissive resin or the like, and guide the image light output by the right display unit 22 and the left display unit 24 to the eye of the user. A light control plate may be provided on the surfaces of the right light guide plate 26 and the left light guide plate 28. The light control plate is a thin plate-like optical element having different transmittance depending on the wavelength range of light, and functions as a so-called wavelength filter. For example, the light control plate is arranged so as to cover the surface of the front frame 27 (the surface opposite to the surface facing the user's eye). It is possible to adjust the transmittance of light in an arbitrary wavelength range such as visible light, infrared light, and ultraviolet light, and to adjust the light intensity of the external light incident on the right light guide plate 26 and the left light guide plate 28 from the outside and passing through the right light guide plate 26 and the left light guide plate 28, by appropriately selecting the optical characteristics of the light control plate.

The image display unit 20 guides the image light generated by the right display unit 22 and the left display unit 24 respectively to the right light guide plate 26 and the left light guide plate 28, and allows the user to view this image (augmented reality (AR) image) by this image light (this is also referred to as “displaying image”). When external light passes through the right light guide plate 26 and the left light guide plate 28 from the front of the user and is incident on the user's eye, the image light forming an image and the external light are incident on the user's eye. Therefore, the visibility of the image in the user is influenced by the strength of the external light.

Therefore, it is possible to adjust the easiness of visual recognition of an image, by attaching, for example, a light control plate to the front frame 27 and appropriately selecting or adjusting the optical characteristics of the light control plate. In a typical example, it is possible to select a light control plate having a light transmissive property of an extent that the user wearing the HMD 100 can view at least the outside scene. If the light control plate is used, an effect can be expected to protect the right light guide plate 26 and the left light guide plate 28, and reduce the damage of the right light guide plate 26 and the left light guide plate 28, adhesion of dirt thereto, or the like. The light control plate may be detachable to the front frame 27, or the right light guide plate 26 and the left light guide plate 28, respectively. The light control plate may be detachable by exchanging plural types of light control plates, or the light control plate may be omitted.

A camera 61 is disposed in the front frame 27 of the image display unit 20. The camera 61 is provided in the front surface of the front frame 27 at a position not obstructing the external light transmitting the right light guide plate 26 and the left light guide plate 28. In the example of FIG. 1, the camera 61 is disposed on the end portion ER side of the front frame 27. The camera 61 may be disposed on the end EL side of the front frame 27, or may be disposed at the connecting portion between the right light guide plate 26 and the left light guide plate 28.

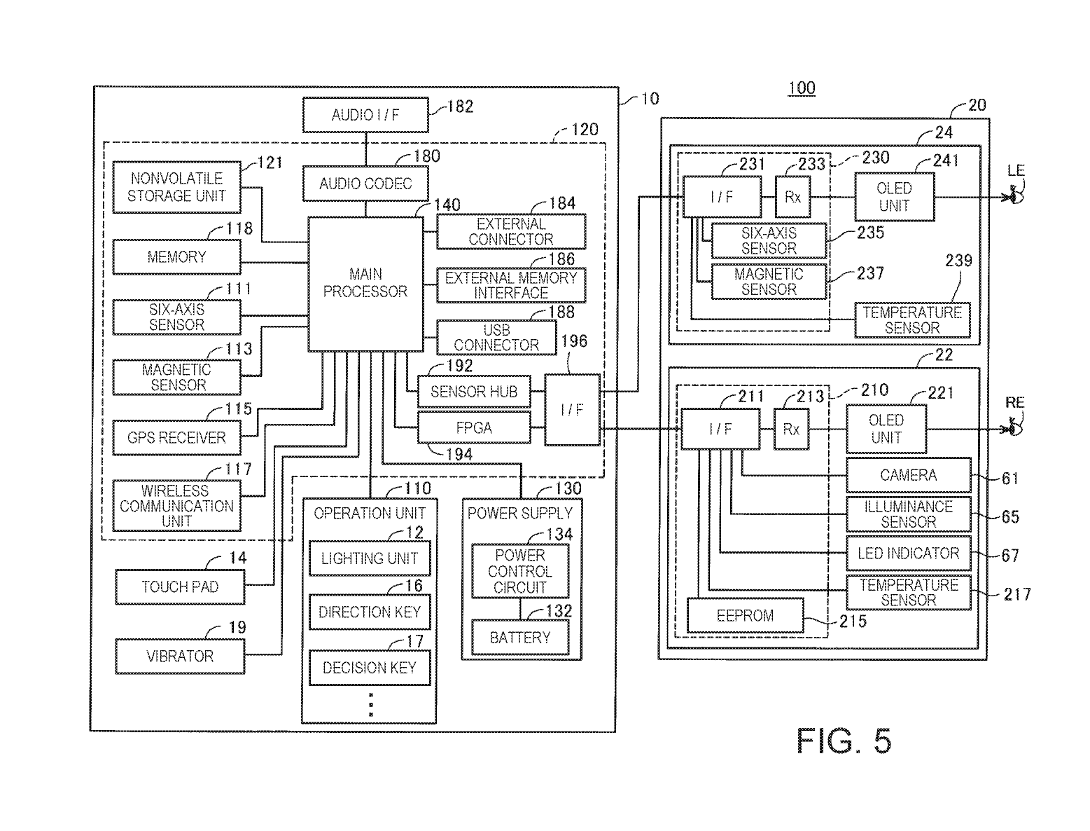

The camera 61 is a digital camera including an image pickup device such as a CCD or a CMOS, an imaging lens, and the like. In the present embodiment, the camera 61 is a monocular camera, but a stereo camera may be adopted. The camera 61 captures at least a portion of outside scene (real space) in the front direction of the HMD 100, in other words, in the view direction visually recognized by the user, in the state of wearing the image display unit 20. In other words, the camera 61 captures an image in a range or a direction overlapping the field of view of the user, and captures an image in a direction viewed by the user. The size of the angle of view of the camera 61 can be set as appropriate. In the present embodiment, the size of the angle of view of the camera 61 is set such that the image of the entire field of view of the user that can be viewed through the right light guide plate 26 and the left light guide plate 28 is captured. The camera 61 performs imaging according to the control of a control function unit 150 (FIG. 5) and outputs the obtained imaging data to the control function unit 150.

The HMD 100 may be equipped with a distance sensor that detects the distance to an object to be measured located in the preset measurement direction. The distance sensor can be disposed at, for example, a connecting portion between the right light guide plate 26 and the left light guide plate 28 of the front frame 27. The measurement direction of the distance sensor can be the front direction of the HMD 100 (the direction overlapping the imaging direction of the camera 61). The distance sensor can be configured with, for example, a light emitting unit such as an LED, or a laser diode, and a light receiving unit that receives reflected light that the light emitted from the light source reflects on the object to be measured. In this case, a distance is obtained, by a triangulation distance measurement process, or a distance measurement process based on a time difference. The distance sensor may be configured with, for example, a transmitter that emits ultrasonic waves and a receiver that receives ultrasonic waves reflected by an object to be measured. In this case, a distance is obtained, by a distance measurement process based on a time difference. Similar to the camera 61, the distance sensor is controlled by the control function unit 150, and outputs the detection result to the control function unit 150.

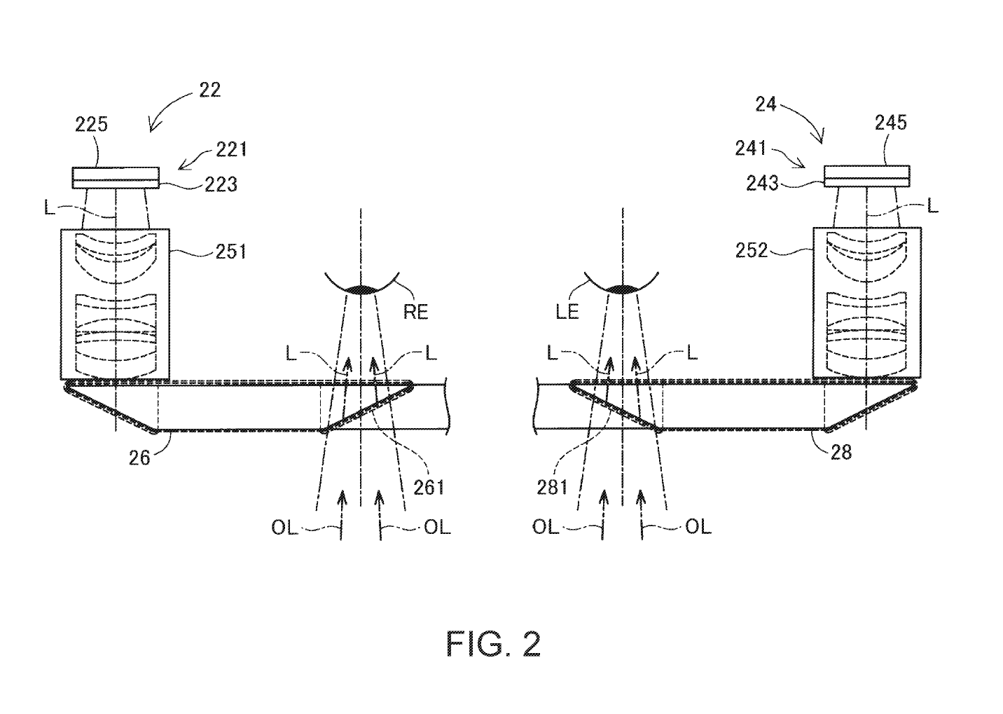

FIG. 2 is a plan view of a main part illustrating a configuration of an optical system included in the image display unit 20. For the convenience of explanation, FIG. 2 illustrates the right eye RE and the left eye LE of the user. As illustrated in FIG. 2, the right display unit 22 and the left display unit 24 are configured symmetrically to the left and the right.

The right display unit 22 includes an organic light emitting diode (OLED) unit 221, and a right optical system 251 as a configuration for allowing the right eye RE to view an image (AR image). The OLED unit 221 emits image light. The right optical system 251 includes a lens group, and guides an image light L emitted from the OLED unit 221 to the right light guide plate 26.

The OLED unit 221 includes an OLED panel 223, and an OLED drive circuit 225 that drives the OLED panel 223. The OLED panel 223 is a self-emitting display panel configured with light emitting elements that emit light by organic electroluminescence, and emit color lights of red (R), green (G), and blue (B), respectively. In the OLED panel 223, a plurality of pixels are arranged in a matrix, each pixel having respective one R, G, and B elements.

The OLED drive circuit 225 selects light emitting elements and supplies of power to the light emitting elements included in the OLED panel 223 under the control of the control function unit 150 (FIG. 5), and causes the light emitting element to emit light. The OLED drive circuit 225 is fixed to the back surface of the OLED panel 223, that is, the back side of the light emitting surface by bonding or the like. The OLED drive circuit 225 may be configured with, for example, a semiconductor device that drives the OLED panel 223, and may be mounted on a substrate fixed to the back surface of the OLED panel 223. A temperature sensor 217 (FIG. 5) which will be described later is mounted on the substrate. In addition, the OLED panel 223 may have a configuration in which light emitting elements that emit white light are arranged in a matrix and color filters corresponding to the respective colors R, G, and B are superimposed and arranged. An OLED panel 223 having a WRGB configuration may be adopted in which a light emitting element that emits light of W (white) is provided in addition to the light emitting elements that emit respective colors R, G, and B.

The right optical system 251 includes a collimating lens that makes the image light L emitted from the OLED panel 223 into a parallel light flux. The image light L made into the parallel light flux by the collimating lens enters the right light guide plate 26. A plurality of reflecting surfaces reflecting the image light L are formed in a light path guiding the light inside the right light guide plate 26. The image light L is guided to the right eye RE side by being subjected to a plurality of reflections inside the right light guide plate 26. A half mirror 261 (reflective surface) located in front of the right eye RE is formed on the right light guide plate 26. After being reflected by the half mirror 261, the image light L is emitted from the right light guide plate 26 to the right eye RE, and this image light L forms an image on the retina of the right eye RE, thereby allowing the user to view the image.

The left display unit 24 includes an OLED unit 241 and a left optical system 252, as a configuration allowing the left eye LE to view an image (AR image). The OLED unit 241 emits image light. The left optical system 252 includes a lens group, and guides the image light L emitted from the OLED unit 241 to the left light guide plate 28. The OLED unit 241 includes an OLED panel 243, and an OLED drive circuit 245 that drives the OLED panel 243. The details of the respective parts are the same as those of the OLED unit 221, the OLED panel 223, and the OLED drive circuit 225. A temperature sensor 239 is mounted on a substrate fixed to the back surface of the OLED panel 243. The details of the left optical system 252 are the same as those of the right optical system 251.

According to the above-described configuration, the HMD 100 can function as a see-through type display device. In other words, the image light L reflected by the half mirror 261 and the external light OL passing through the right light guide plate 26 are incident on the user's right eye RE. The image light L reflected by a half mirror 281 and the external light OL passing through the left light guide plate 28 are incident on the user's left eye LE. The HMD 100 causes the image light L of the internally processed image and the external light OL to be incident on the eye of the user in an overlapping manner. As a result, the outside scene (real world) is visible through the right light guide plate 26 and the left light guide plate 28, and an image (AR image) by the image light L is viewed by the user so as to be superimposed on this outside scene.

The half mirror 261 and the half mirror 281 each functions as “image pickup unit” that reflects the image light output from each of the right display unit 22 and the left display unit 24 and extracts the image. The right optical system 251 and the right light guide plate 26 are collectively referred to as “right light guide portion”, and the left optical system 252 and the left light guide plate 28 are also referred to as “a left light guide portion.” The configurations of the right light guide portion and the left light guide portion are not limited to the above example, and an arbitrary method can be used as long as an image is formed in front of the eye of the user using image light. For example, diffraction gratings may be used, or transflective films may be used, for the right light guide portion and the left light guide portion.

In FIG. 1, the control device 10 and the image display unit 20 are connected by a connection cable 40. The connection cable 40 is detachably connected to a connector provided at the bottom of the control device 10, and is connected from the tip of the left holding unit 23 to various circuits inside the image display unit 20. The connection cable 40 has a metal cable or an optical fiber cable for transmitting digital data. The connection cable 40 may further include a metal cable for transmitting analog data. A connector 46 is provided in the middle of the connection cable 40.

The connector 46 is a jack for connecting a stereo mini plug, and the connector 46 and the control device 10 are connected by, for example, a line for transferring analog audio signals. In the example of the present embodiment illustrated in FIG. 1, a right earphone 32 and a left earphone 34 constituting a stereo headphone and a head set 30 having a microphone 63 are connected to the connector 46.

For example, the microphone 63 is arranged so that the sound pickup portion of the microphone 63 faces the user's line-of-sight direction, as illustrated in FIG. 1. The microphone 63 picks up audio and outputs the audio signal to an audio interface 182 (FIG. 5). The microphone 63 may be a monaural microphone or a stereo microphone, or may be a directional microphone or an omnidirectional microphone.

The control device 10 is a device that controls the HMD 100. The control device 10 includes a lighting unit 12, a touch pad 14, a direction key 16, a decision key 17, and a power switch 18. The lighting unit 12 notifies of the operation state (for example, power ON/OFF, or the like) of the HMD 100 by its light emission mode. For example, a light emitting diode (LED) can be used as the lighting unit 12.

The touch pad 14 detects a touch operation on the operation surface of the touch pad 14, and outputs a signal corresponding to the detection content. Various touch pads such as an electrostatic type, a pressure detection type, and an optical type may be adopted as the touch pad 14. When a pressing operation to the key corresponding to each of Up, Down, Right, and Left directions of the direction key 16 is detected, a signal corresponding to the detected contents is output. When a press operation of the decision key 17 is detected, a signal for deciding the content operated in the control device 10 is output. When the slide operation of the power switch 18 is detected, the power-on state of the HMD 100 is switched.

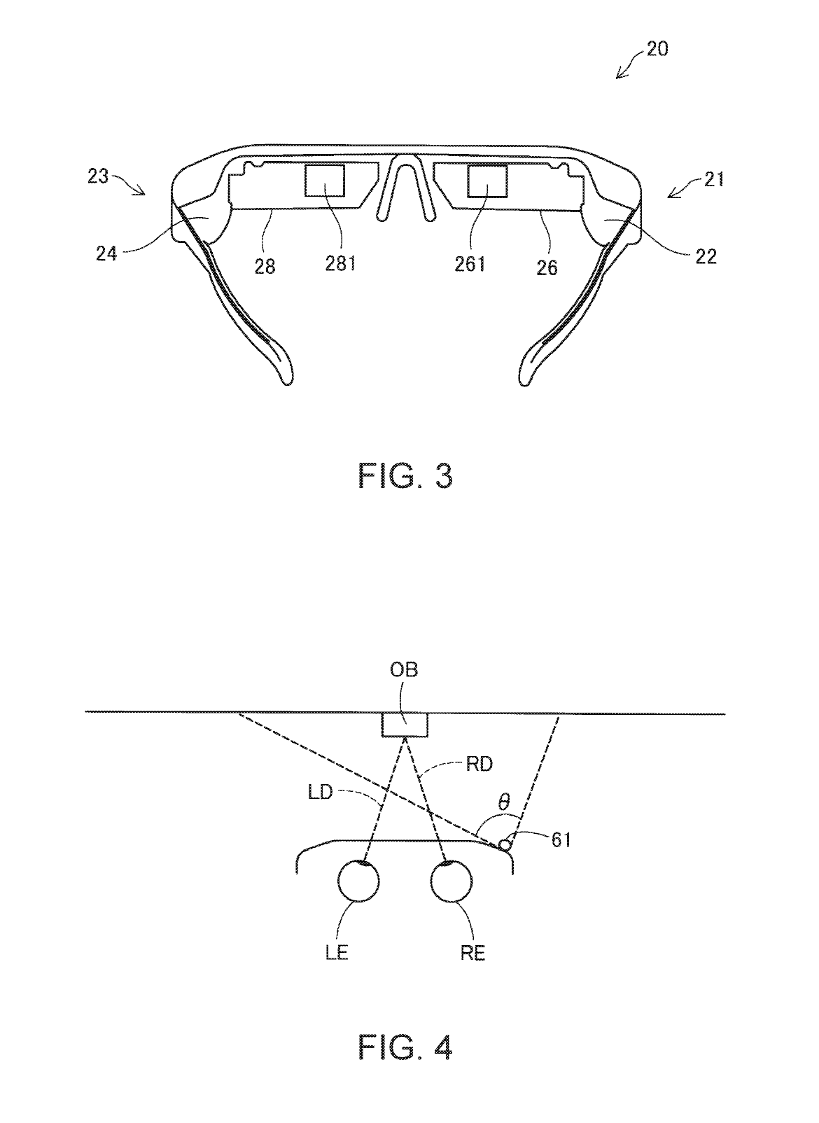

FIG. 3 is a diagram illustrating a configuration of the essential parts of the image display unit 20 viewed from the user. In FIG. 3, the illustration of the connection cable 40, the right earphone 32, and the left earphone 34 is omitted. In the state of FIG. 3, the back sides of the right light guide plate 26 and the left light guide plate 28 are visible, and the half mirror 261 illuminating the image light to the right eye RE and the half mirror 281 illuminating the image light to the left eye LE are visible as substantially rectangular areas. The user views the outside scene through the whole of the left and right light guide plates 26 and 28 including the half mirrors 261 and 281, and views a rectangular display image at the positions of the half mirrors 261 and 281.

FIG. 4 is a diagram illustrating an angle of view of the camera 61. In FIG. 4, the camera 61 and the user's right eye RE and left eye LE are schematically illustrated in a plan view, and the angle of view (imaging range) of the camera 61 is denoted by θ. The angle θ of view of the camera 61 extends in the horizontal direction as illustrated in FIG. 4, and also extends in the vertical direction similar to a general digital camera.

As described above, the camera 61 is disposed at the end portion on the right side of the image display unit 20, and captures an image in the line-of-sight direction of the user (that is, the front of the user). Therefore, the optical axis of the camera 61 is in a direction including the line-of-sight directions of the right eye RE and the left eye LE. The outside scene that the user can view in the state of wearing the HMD 100 is not limited to infinity. For example, when the user gazes at the object OB with both eyes, the line of sight of the user is directed to the object OB as indicated by reference symbols RD and LD in FIG. 4. In this case, the distance from the user to the object OB is likely to be about 30 cm to 10 m, and is more likely to be 1 m to 4 m. Therefore, a measure of the upper limit and the lower limit of the distance from the user to the object OB at the time of normal use may be set for the HMD 100. This measure may be determined in advance and pre-set in the HMD 100, or may be set by the user. It is preferable that the optical axis and the angle of view of the camera 61 are set such that the object OB is included in the angle of view when the distance to the object OB at the time of normal use corresponds to the measure of the upper limit and the lower limit.

In general, the viewing angle of a human being is set to about 200 degrees in the horizontal direction and about 125 degrees in the vertical direction. Among the viewing angle, the effective visual field with excellent information reception ability is 30 degrees in the horizontal direction and about 20 degrees in the vertical direction. A stable filed of fixation in which a gaze point gazed at by humans seems promptly stable is in a range of 60 to 90 degrees in the horizontal direction and 45 to 70 degrees in the vertical direction. In this case, if the gazing point is an object OB (FIG. 4), the effective field of view is about 30 degrees in the horizontal direction and about 20 degrees in the vertical direction with the lines of sight RD and LD as the center. The stable field of fixation is 60 to 90 degrees in the horizontal direction and about 45 to 70 degrees in the vertical direction. The actual field of view that is viewed by the user through the image display unit 20 and through the right light guide plate 26 and the left light guide plate 28 is referred to as the field of view (FOV). The actual field of view is narrower than the viewing angle and stable field of fixation, but wider than the effective field of view.

The angle θ of view of the camera 61 of the present embodiment is set such that a wider range than the user's field of view can be captured. It is preferable that the angle θ of view of the camera 61 is set such that a wider range than at least the user's effective field of view can be captured, or a wider range than the actual field of view can be captured. It is preferable that the angle θ of view of the camera 61 is set such that a wider range than the user's stable field of fixation can be captured, or a wider range than the viewing angle of both eyes of the user can be captured. Therefore, a so-called wide-angle lens is provided as an imaging lens in the camera 61, and a configuration may be possible which is capable of capturing a wide angle of view. The wide-angle lens may include a super wide-angle lens and a lens called a quasi-wide-angle lens. Further, the camera 61 may include a single focus lens, may include a zoom lens, or may include a lens group including a plurality of lenses.

FIG. 5 is a block diagram functionally illustrating the configuration of the HMD 100. The control device 10 includes a main processor 140 that controls the HMD 100 by executing a program, a storage unit, an input/output unit, sensors, an interface, and a power supply 130. The storage unit, the input/output unit, the sensors, the interface, and the power supply 130 are respectively connected to the main processor 140. The main processor 140 is mounted on a controller substrate 120 incorporated in the control device 10.

The storage unit includes a memory 118 and a nonvolatile storage unit 121. The memory 118 forms a work area for temporarily storing the computer program executed by the main processor 140, and data to be processed. The nonvolatile storage unit 121 is configured with a flash memory or an embedded multi-media card (eMMC). The nonvolatile storage unit 121 stores the computer program executed by the main processor 140 and various data processed by the main processor 140. In the present embodiment, these storage units are mounted on the controller substrate 120.

The input/output unit includes the touch pad 14, and an operation unit 110. The operation unit 110 includes the direction key 16, the decision key 17, and the power switch 18, which are included in the control device 10. The main processor 140 controls each input/output unit, and acquires a signal output from each input/output unit.

The sensors include a six-axis sensor 111, a magnetic sensor 113, and a global positioning system (GPS) receiver 115. The six-axis sensor 111 is a motion sensor (inertial sensor) equipped with a three-axis acceleration sensor and a three-axis gyro (angular velocity) sensor. The six-axis sensor 111 may adopt an inertial measurement unit (IMU) in which these sensors are modularized. The magnetic sensor 113 is, for example, a three-axis geomagnetic sensor. The GPS receiver 115 includes a GPS antenna not illustrated, receives radio signals transmitted from the GPS satellite, and detects the coordinates of the current position of the control device 10. The sensors (the six-axis sensor 111, the magnetic sensor 113, and the GPS receiver 115) output the detection value to the main processor 140 according to the sampling frequency designated in advance. The timing at which each sensor outputs the detection value may be determined in accordance with an instruction from the main processor 140.

The interfaces include a wireless communication unit 117, an audio codec 180, an external connector 184, an external memory interface 186, a universal serial bus (USB) connector 188, a sensor hub 192, an FPGA 194, and an interface 196. They function as interfaces with the outside. The wireless communication unit 117 performs wireless communication between the HMD 100 and the external device. The wireless communication unit 117 is configured with an antenna, an RF circuit, a baseband circuit, a communication control circuit, and the like, not illustrated, or is configured as a device in which these are integrated. The wireless communication unit 117 performs wireless communication conforming to the standards of a wireless LAN including, for example, Bluetooth (registered trademark), Wi-Fi (registered trademark), or the like.

The audio codec 180 is connected to an audio interface 182, and encodes/decodes an audio signal which is input/output through the audio interface 182. The audio interface 182 is an interface that inputs and outputs an audio signal. The audio codec 180 may include an A/D converter that converts an analog audio signal to digital audio data, and a D/A converter that performs the reverse conversion thereof. The HMD 100 of the present embodiment outputs audio from the right earphone 32 and the left earphone 34, and collects the audio by the microphone 63. The audio codec 180 converts a digital audio data output by the main processor 140 into an analog audio signal, and outputs the signal through the audio interface 182. The audio codec 180 converts an analog audio signal input to the audio interface 182 into digital audio data, and outputs the data to the main processor 140.

The external connector 184 is a connector for connecting an external device (for example, a personal computer, a smart phone, a game machine, or the like) that communicates with the main processor 140, to the main processor 140. The external device connected to the external connector 184 can serve as a source of contents, and as well as can be used for debugging the computer program executed by the main processor 140, or for collecting operation logs of the HMD 100. The external connector 184 can adopt various aspects. The external connector 184 can adopt, for example, an interface corresponding to wired connection such as a USB interface, a micro-USB interface, and a memory card interface, or an interface corresponding to the wireless connection such as a wireless LAN interface, or a Bluetooth interface.

The external memory interface 186 is an interface to which a portable memory device can be connected. The external memory interface 186 includes, for example, a memory card slot loaded with a card type recording medium for reading and writing data, and an interface circuit. The size, shape, standard, or the like of the card-type recording medium can be appropriately selected. The USB connector 188 is an interface for connecting a memory device, a smart phone, a personal computer, or the like, conforming to the USB standard. The USB connector 188 includes, for example, a connector conforming to the USB standard, and an interface circuit. The size and shape of the USB connector 188, the version of the USB standard, or the like can be selected as appropriate.

The HMD 100 also includes a vibrator 19. The vibrator 19 includes a motor which is not illustrated, an eccentric rotor, and the like, and generates vibrations under the control of the main processor 140. The HMD 100 generates vibration with a predetermined vibration pattern by the vibrator 19, for example, when an operation on the operation unit 110 is detected, when the power of the HMD 100 is turned on or off, or the like. Instead of being provided in the control device 10, the vibrator 19 may be provided on the image display unit 20 side, for example, in the right holding unit 21 (on the right side of the temple) of the image display unit.

The sensor hub 192 and the FPGA 194 are connected to the image display unit 20 through the interface (I/F) 196. The sensor hub 192 acquires the detection values of the various sensors provided in the image display unit 20, and outputs the values to the main processor 140. The FPGA 194 processes data transmitted and received between the main processor 140 and each part of the image display unit 20 and performs transfer through the interface 196. The interface 196 is connected to the right display unit 22 and the left display unit 24 of the image display unit 20, respectively. In the example of the present embodiment, the connection cable 40 is connected to the left holding unit 23, and the wiring linked to the connection cable 40 is disposed in the inside of the image display unit 20, the right display unit 22 and the left display unit 24 are connected to the interface 196 of the control device 10, respectively.

The power supply 130 includes a battery 132, and a power control circuit 134. The power supply 130 provides power to operate the control device 10. The battery 132 is a rechargeable battery. The power control circuit 134 detects the remaining capacity of the battery 132 and controls the charging to an OS 143. The power control circuit 134 is connected to the main processor 140, and outputs the detected value of the remaining capacity of the battery 132 and the detected value of the voltage of the battery 132 to the main processor 140. Power may be supplied from the control device 10 to the image display unit 20, based on the electric power supplied by the power supply 130. It may be configured such that the state of the supply of power from the power supply 130 to each part of the control device 10 and the image display unit 20 is controlled by the main processor 140.

The right display unit 22 includes a display unit substrate 210, the OLED unit 221, the camera 61, an illuminance sensor 65, an LED indicator 67, and the temperature sensor 217. An interface (I/F) 211 connected to the interface 196, a receiver (Rx) 213, and an electrically erasable programmable read-only memory (EEPROM) 215 are mounted on the display unit substrate 210. The receiver 213 receives data input from the control device 10 through the interface 211. When receiving the image data of the image displayed by the OLED unit 221, the receiver 213 outputs the received image data to the OLED drive circuit 225 (FIG. 2).

The EEPROM 215 stores various types of data in such a manner that the main processor 140 can read the data. The EEPROM 215 stores, for example, data about the light emission characteristics and the display characteristics of the OLED units 221 and 241 of the image display unit 20, data about the sensor characteristics of the right display unit 22 and the left display unit 24, and the like. Specifically, the EEPROM 215 stores, for example, parameters relating to gamma correction of the OLED units 221 and 241, data for compensating the detection values of the temperature sensors 217 and 239 described later, and the like. These data are generated by factory shipment inspection of the HMD 100 and written in the EEPROM 215. After shipment, the main processor 140 reads the data of the EEPROM 215 and uses the data for various processes.

The camera 61 implements imaging according to the signal input through the interface 211, and outputs imaging image data or a signal indicating an imaging result to the control device 10. As illustrated in FIG. 1, the illuminance sensor 65 is provided at the end ER of the front frame 27, and is disposed to receive external light from the front of the user wearing the image display unit 20. The illuminance sensor 65 outputs a detection value corresponding to the amount of received light (received light intensity). As illustrated in FIG. 1, the LED indicator 67 is disposed in the vicinity of the camera 61 at the end ER of the front frame 27. The LED indicator 67 is lit up during imaging by the camera 61 and informs that the image is being captured.

The temperature sensor 217 detects the temperature and outputs a voltage value or a resistance value corresponding to the detected temperature. The temperature sensor 217 is mounted on the back side of the OLED panel 223 (FIG. 3). The temperature sensor 217 may be mounted on, for example, the same substrate as that of the OLED drive circuit 225. With this configuration, the temperature sensor 217 mainly detects the temperature of the OLED panel 223. The temperature sensor 217 may be incorporated in the OLED panel 223 or the OLED drive circuit 225. When the OLED panel 223 is, for example, a Si-OLED, and the OLED panel 223 and the OLED drive circuit 225 are mounted as an integrated circuit on an integrated semiconductor chip, the temperature sensor 217 may be mounted on the semiconductor chip.

The left display unit 24 includes a display unit substrate 230, the OLED unit 241, and the temperature sensor 239. An interface (I/F) 231 connected to the interface 196, a receiver (Rx) 233, a six-axis sensor 235, and a magnetic sensor 237 are mounted on the display unit substrate 230. The receiver 233 receives data input from the control device 10 through the interface 231. When receiving the image data of the image displayed by the OLED unit 241, the receiver 233 outputs the received image data to the OLED drive circuit 245 (FIG. 2).

The six-axis sensor 235 is a motion sensor (inertial sensor) equipped with a three-axis acceleration sensor and a three-axis gyro (angular velocity) sensor. An IMU in which the above sensors are modularized may be adopted as the six-axis sensor 235. The magnetic sensor 237 is, for example, a three-axis geomagnetic sensor. Since the six-axis sensor 235 and the magnetic sensor 237 are provided in the image display unit 20, when the image display unit 20 is mounted on the head of the user, the movement of the head of the user is detected. The orientation of the image display unit 20, that is, the field of view of the user is specified based on the detected movement of the head.

The temperature sensor 239 detects the temperature and outputs a voltage value or a resistance value corresponding to the detected temperature. The temperature sensor 239 is mounted on the back side of the OLED panel 243 (FIG. 3). The temperature sensor 239 may be mounted on, for example, the same substrate as that of the OLED drive circuit 245. With this configuration, the temperature sensor 239 mainly detects the temperature of the OLED panel 243. The temperature sensor 239 may be incorporated in the OLED panel 243 or the OLED drive circuit 245. The details are the same as those of the temperature sensor 217.

The camera 61, the illuminance sensor 65, and the temperature sensor 217 of the right display unit 22, and the six-axis sensor 235, the magnetic sensor 237, and the temperature sensor 239 of the left display unit 24 are connected to the sensor hub 192 of the control device 10. The sensor hub 192 sets and initializes the sampling period of each sensor under the control of the main processor 140. The sensor hub 192 supplies power to each sensor, transmits control data, acquires a detection value, or the like, in accordance with the sampling period of each sensor. The sensor hub 192 outputs the detection value of each sensor provided in the right display unit 22 and the left display unit 24 to the main processor 140 at a preset timing. The sensor hub 192 may be provided with a cache function of temporarily holding the detection value of each sensor. The sensor hub 192 may be provided with a conversion function of a signal format or a data format of the detection value of each sensor (for example, a conversion function into a unified format). The sensor hub 192 starts or stops supply of power to the LED indicator 67 under the control of the main processor 140 to turn on or off the LED indicator 67.

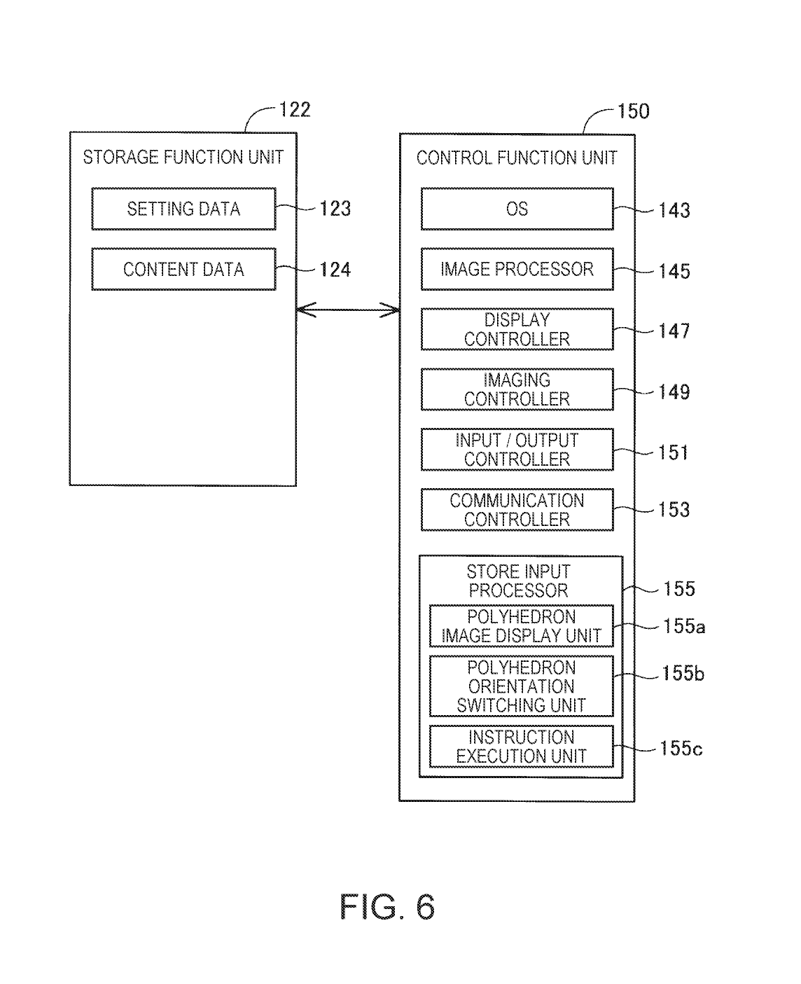

FIG. 6 is a block diagram functionally illustrating the configuration of the control device 10. The control device 10 functionally includes a storage function unit 122, and the control function unit 150. The storage function unit 122 is a logical storage unit configured with the nonvolatile storage unit 121 (FIG. 5). Instead of the configuration of only using the storage function unit 122, a configuration may be possible such that the storage function unit 122 is combined with the nonvolatile storage unit 121, and the EEPROM 215 or the memory 118 is used. The control function unit 150 is configured by the main processor 140 executing a computer program, that is, by cooperation of hardware and software.

The storage function unit 122 stores various data to be processed in the control function unit 150. Specifically, a setting data 123 and a content data 124 are stored in the storage function unit 122 of the present embodiment. The setting data 123 includes various setting values related to the operation of the HMD 100. For example, the setting data 123 includes parameters, a determinant, an arithmetic expression, and a look up table (LUT) when the control function unit 150 controls the HMD 100.

The content data 124 includes data (image data, video data, audio data, or the like) of contents including image and video displayed by the image display unit 20 under the control of the control function unit 150. Data of bidirectional type content may be included in the content data 124. The bidirectional type content means a content of a type in which the operation of the user is acquired by the operation unit 110, the process corresponding to the acquired operation content is performed by the control function unit 150, and content corresponding to the processed content is displayed on the image display unit 20. In this case, content data includes image data of a menu screen for acquiring user's operation, data defining a process corresponding to items included in the menu screen, and the like.

The control function unit 150 executes functions as the OS 143, an image processor 145, a display controller 147, an imaging controller 149, an input/output controller 151, a communication controller 153, and a store input processor 155, by executing various processes using the data stored in the storage function unit 122. In the present embodiment, each functional unit other than the OS 143 is configured as a computer program executed on the OS 143.

The image processor 145 generates signals to be transmitted to the right display unit 22 and the left display unit 24, based on an image/image data of video displayed by the image display unit 20. The signals generated by the image processor 145 may be a vertical sync signal, a horizontal sync signal, a clock signal, an analog image signal, and the like. The image processor 145 may be configured with hardware (for example, a digital signal processor (DSP)) other than the main processor 140, in addition to the configuration realized by the main processor 140 executing the computer program.

The image processor 145 may execute a resolution conversion process, an image adjustment process, a 2D/3D conversion process, or the like, as necessary. The resolution conversion process is a process of converting the resolution of the image data into a resolution suitable for the right display unit 22 and the left display unit 24. The image adjustment process is a process of adjusting the brightness and saturation of image data. The 2D/3D conversion process is a process of generating two-dimensional image data from three-dimensional image data, or generating three-dimensional image data from two-dimensional image data. When executing these processes, the image processor 145 generates a signal for displaying an image based on the processed image data, and transmits the signal to the image display unit 20 through the connection cable 40.

The display controller 147 generates a control signal for controlling the right display unit 22 and the left display unit 24, and controls the generation and emission of image light by each of the right display unit 22 and the left display unit 24, according to this control signal. Specifically, the display controller 147 controls the OLED drive circuits 225 and 245 so as to display images by the OLED panels 223 and 243. The display controller 147 controls the timing at which the OLED drive circuits 225 and 245 perform drawing on the OLED panels 223 and 243, and controls the brightness of the OLED panels 223 and 243, based on the signal output from the image processor 145.

The imaging controller 149 controls the camera 61 so as to perform imaging, generates imaging image data, and temporarily stores the data in the storage function unit 122. If the camera 61 is configured with a camera unit including a circuit that generates imaging image data, the imaging controller 149 acquires the imaging image data from the camera 61 and temporarily stores the data in the storage function unit 122.

The input/output controller 151 appropriately controls the touch pad 14 (FIG. 1), the direction key 16, and the decision key 17, and acquires an input command therefrom. The acquired command is output to the OS 143, or the OS 143 and the computer program operating on the OS 143. The communication controller 153 controls the wireless communication unit 117 so as to perform wireless communication with, for example, the store server 300.

The store input processor 155 is a function realized according to an application program operating on the OS 143. The store input processor 155 cooperates with the input/output controller 151, the image processor 145, and the display controller 147 so as to acquire the identification information of the store desired by the user. Specifically, the store input processor 155 has a function of presenting a plurality of candidate stores sent from the store server 300 to a user, and a function of receiving an input of one store selected by the user from the plurality of candidate stores. The function of receiving an input of a store which is the latter function is realized by a polyhedron image display unit 155a, a polyhedron orientation switching unit 155b, and an instruction execution unit 155c. Details of respective units 155a to 155c are as follows. The configuration of the image processor 145, the display controller 147, and the image display unit 20 corresponds to a “display unit”, and the store input processor 155 corresponds to “processor”, according to the invention described in the Summary section.

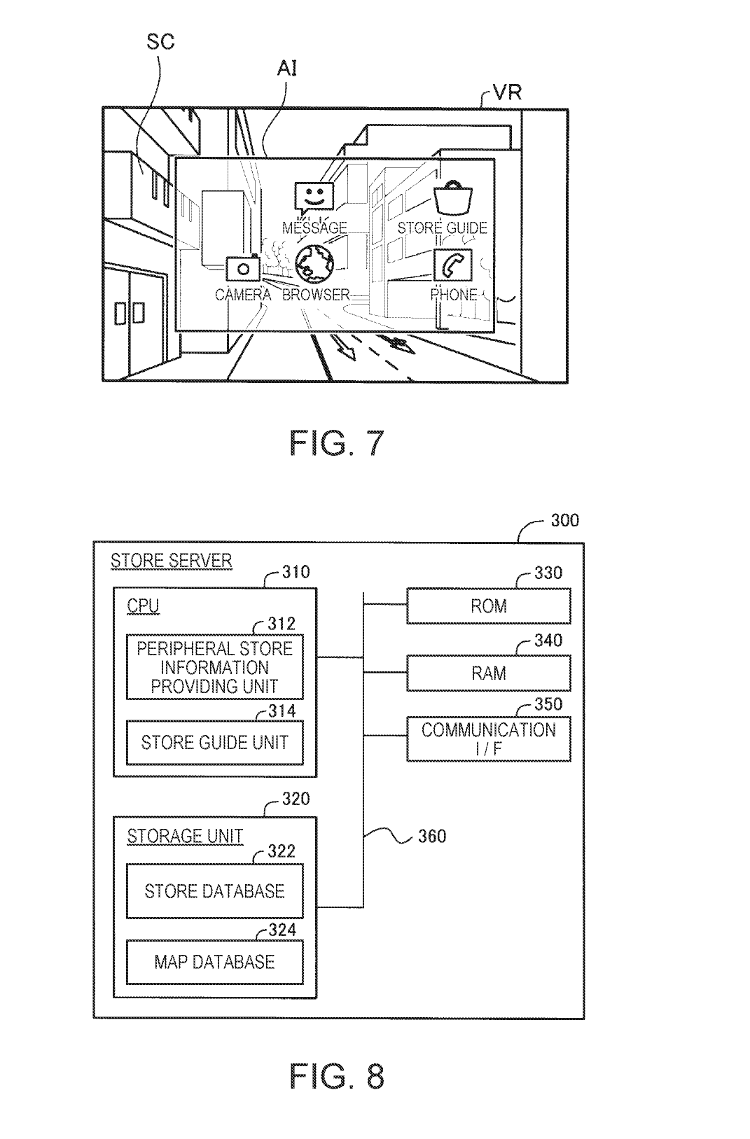

FIG. 7 is an explanatory diagram illustrating an example of augmented reality display by the HMD 100. FIG. 7 illustrates the field VR of view of the user. As described above, the image light guided to both eyes of the user of the HMD 100 forms an image on the retina of the user, and thus the user views the image AI as an augmented reality (AR). In the example of FIG. 7, the image AI is a menu screen of the OS of the HMD 100. The menu screen includes icons for activating each application program such as, for example, “message”, “telephone”, “camera”, “browser”, and “store guide.” Since the right and left light guide plates 26 and 28 transmit light from the outside scene SC, the user views the outside scene SC. In this manner, the user of the HMD of this embodiment can view the image AI superimposed on the outside scene SC, for a portion in which an image VI is displayed in the field VR of view. Further, the user can view only the outside scene SC, for a portion in which the image AI is not displayed in the field VR of view.

### A-3. Configuration of Store Server

FIG. 8 is a block diagram functionally illustrating the configuration of the store server 300. As illustrated in FIG. 4, the store server 300 includes a CPU 310, a storage unit 320, a ROM 330, a RAM 340, and a communication interface (I/F) 350, and the respective units are connected to each other through a bus 360.

The CPU 310 controls the respective units of the store server 300, by developing the computer program stored in the storage unit 320 and the ROM 330 in the RAM 340, and executing the program. In addition, the CPU 310 also functions as a peripheral store information providing unit 312 and a store guide unit 314. The peripheral store information providing unit 312 provides stores within a range of a field VR1 of view of the user as candidate stores, to the HMD 100. The store guide unit 314 receives identification information of a store wanted by the user from the HMD 100, acquires guidance information on the store wanted by the user from a store database 322, and provides the acquired store information to the HMD 100. In this embodiment, useful information for using stores such as information indicating a route to the store and a telephone number of the store is provided as the guidance information.

The storage unit 320 includes a ROM, a RAM, a DRAM, a hard disk, and the like. Various computer programs including an operating system (OS) are stored in the storage unit 320. The storage unit 320 stores the aforementioned store database 322 and a map database 324. Various stores are recorded in the map database 324.

### A-4. Regarding Store Input Process

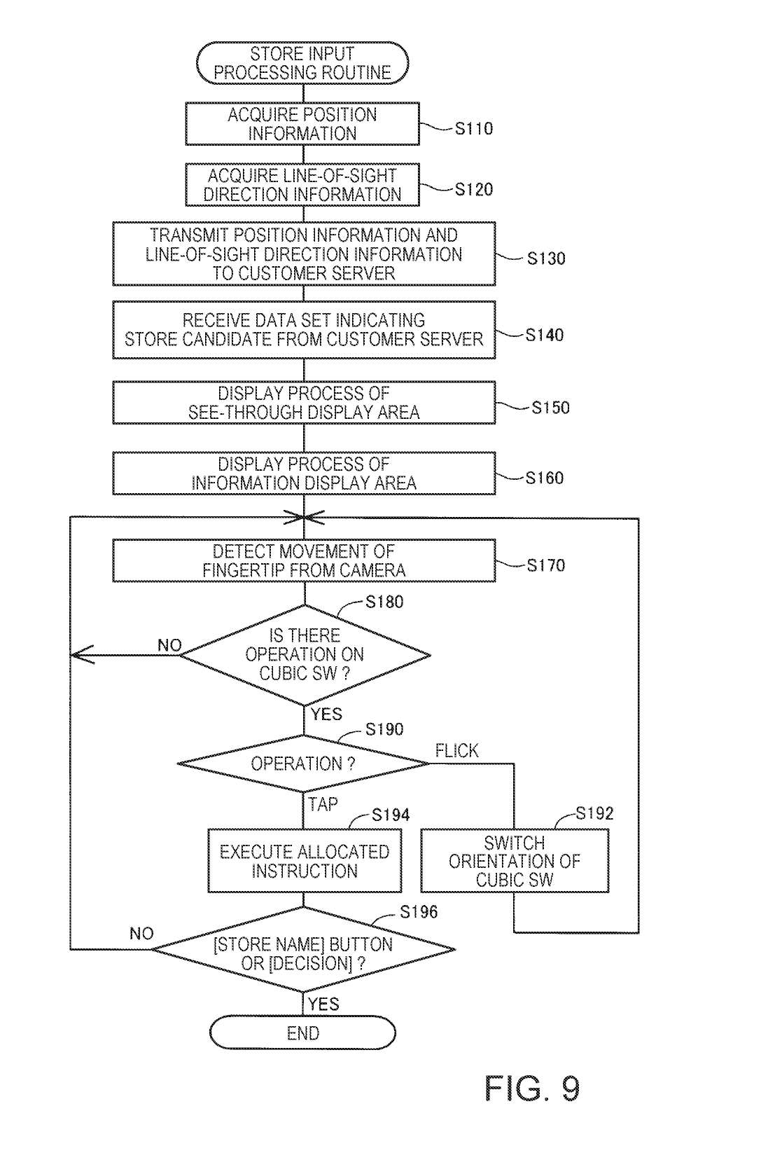

FIG. 9 is a flowchart illustrating a store input processing routine. The store input processing routine corresponds to the store input processor 155 (FIG. 6). The store input processing routine is a processing routine according to a predetermined computer program (application program) stored in the nonvolatile storage unit 121 (FIG. 5), and is executed by the main processor 140 of the HMD 100. When receiving the designation of the icon of “store guide” on the menu screen illustrated in FIG. 7 by the direction key 16 (FIG. 1) and the decision key 17 (FIG. 1), the execution of the store input processing routine is started.

When the process is started, the main processor 140 of the HMD 100 first acquires position information indicating the current position of the HMD 100 from the GPS receiver 115 (step S110). Next, the main processor 140 acquires information (line-of-sight direction information) specifying the line-of-sight direction of the user wearing the image display unit 20 (step S120). Specifically, the line-of-sight direction information is acquired by specifying the orientation of the image display unit 20 based on the geomagnetism detected by the magnetic sensor 237. Subsequently, the main processor 140 transmits the position information and the line-of-sight direction information, which are acquired, to the store server 300 (step S130).

When the process of step S130 is performed, the following processes are performed on the store server 300 side. The store server 300 first acquires the position information and the line-of-sight information, and sets the virtual field of view of the user, based on these pieces of information. Specifically, a range (for example, left right 90 degrees, up and down 60 degrees) which is preset, with the line-of-sight direction of the user as the center, at a current position of the HMD 100, is set as the virtual field of view. In addition, “virtual field of view” used herein does not necessarily need to match the field of view (actual field of view) that the user can actually view through the right and left light guide plates 26 and 28, but the range not exceeding the actual field of view is desired. Subsequently, the store server 300 searches for stores included in the virtual field of view, by matching the map database 324. Here, stores included in the virtual field of view are searched, for example, with the distance from the HMD 100 as several hundred meters. Thereafter, the store server 300 sets the searched store as a candidate store, and acquires information on each candidate store from the store database 322. Thereafter, the store server 300 transmits to the HMD 100, a data set indicating information on each acquired candidate store.

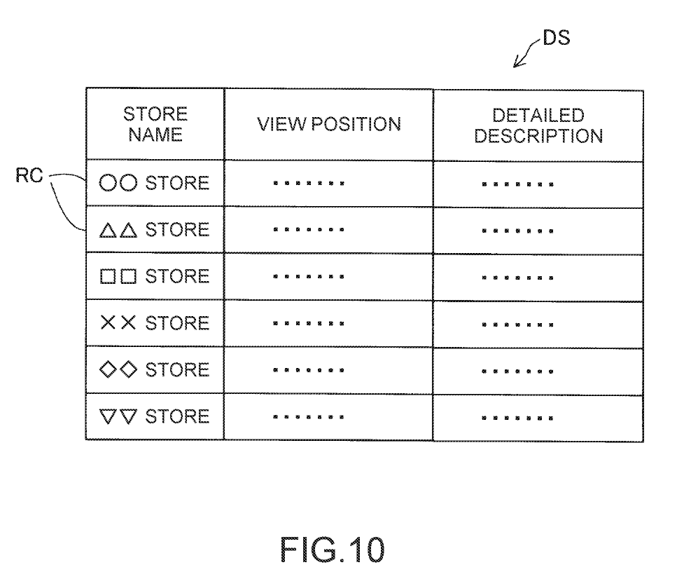

FIG. 10 is an explanatory diagram illustrating a data set DS transmitted from the store server 300 to the HMD 100. The data set DS records information on each candidate store in the form of records RC. Each data of “Store name”, “View position”, and “Detailed description” is recorded in each record RC. The data of “Store name” is the name of the candidate store, and the data of “View position” is information indicating the position of the candidate store in the above-described virtual field of view. The data of “Detailed description” indicates detailed information on the candidate store, specifically, the type of a store (for example, a convenience store, a restaurant, a tavern, or the like), items to be handled, and the like.

In step S140 subsequent to step S130 of FIG. 9, the main processor 140 receives the above-mentioned data set from the store server 300. Next, the main processor 140 controls the image processor 145 (FIG. 6) based on the received data set, and performs a display process of causing the display controller 147 (FIG. 6) to display a see-through display area (step S150). Subsequently, the main processor 140 controls the image processor 145 (FIG. 6) based on the received data set so as to execute a display process of causing the display controller 147 (FIG. 6) to display the information display area (step S160). The process of step S160 corresponds to the polyhedron image display unit 155a (FIG. 6).

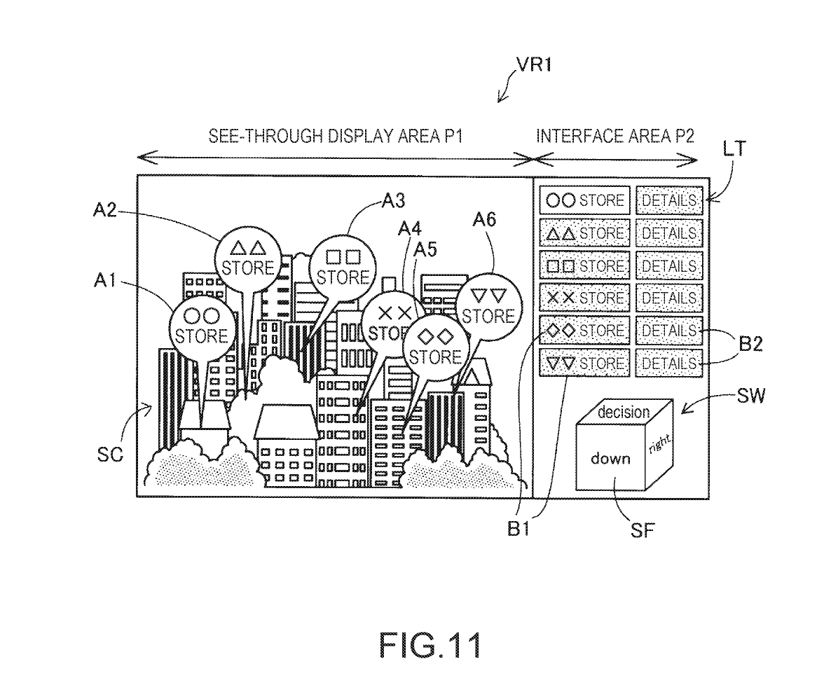

FIG. 11 is an explanatory diagram illustrating an example of the field VR1 of view of the user after the process of step S160 is executed. As illustrated, the field VR1 of view includes a see-through display area P1 and an interface area P2.

Speech bubbles A1 to A6 of store names are displayed as AR images so as to be superimposed on the outside scene SC, in the see-through display area P1. The store names presented in the speech bubbles A1 to A6 are based on the data of “store name” of the received data set DS. The display positions of the respective speech bubbles A1 to A6 correspond to the positions where the candidate stores are present and are determined based on the data of the “view position” of the received data set DS. Specifically, after setting the same virtual field of view as the virtual field of view set by the store server 300 in the field VR1 of view, the position in the set virtual field of view is obtained from the data of the “view position”, such that the display positions of the respective speech bubbles A1 to A6 in the field VR1 of view are determined.

The interface area P2 is an area for exchanging information among the users, and is connected to one side (for example, the right side) of the see-through display area P1. Specifically, in the interface area P2, one or more (six in the illustration of FIG. 11) store names displayed in the see-through display area P1 are displayed as a list, and at the same time the store name of the store which is selected from the displayed list and is desired by user is received. The amount of transmission of the outside scene is set for the interface area P2 such that a far outside scene is not transmitted and a nearby outside scene (for example, a fingertip) is transmitted and visible.

The interface area P2 illustrated in FIG. 11 includes a list display field LT and a cubic switch SW.

In the list display field LT, [Store name] buttons B1 corresponding to the store names displayed in the see-through display area P1 are vertically arranged, and the [Details] buttons B2 are respectively provided in the right side next to the respective [Store name] buttons. That is, the [Store name] button B1 and the [Details] button B2 are provided in a pair for each store. The [Store name] button B1 is a switch for instructing the control function unit 150 (FIG. 6) of the HMD 10 to inform a store name. The [Details] button B2 is a switch for instructing display of detailed information of the store. One of all the buttons B1 and B2 in the list display field LT is in an active state, and the remaining buttons B1 and B2 are in an inactive state. The “active state” is a state which is a target of the operation by the user. In the illustrated example, the [Store name] button B1 of “OO store” is a white background and is in an active state, and the remaining buttons B1 and B2 are in the inactive state. In the illustrated example, the [Details] button B2 of “OO store” and the [Store name] button B1 and [Details] button B2 of each store other than “OO store” are inactive. In addition, the list display field LT corresponds to “image” according to the invention described in the Summary section.

The cubic switch SW functions as a graphical user interface (GUI) for sequentially switching buttons B1 and B2 which are in an active state and deciding a store that the user wants to input. In the present embodiment, the cubic switch SW is formed of a 3D image of a cube (regular hexahedron) shape. “3D image” is a three-dimensional (stereoscopic) image. In this embodiment, the image of a cube is displayed by three-dimensional shape data having a depth, and it is possible to freely change the angle on a two-dimensional screen, and to give a perspective feeling. Since the HMD 100 of this embodiment is a see-through type, a specific image process may be performed and the 3D image may be stereoscopically displayed. The specific image process includes shadowing, changing brightness, changing the parallax angle of both eye displays, and the like.

One instruction is allocated to each surface SF of the cube. The instructions allocated to six surfaces SF are “Up”, “Down”, “Right”, “Left”, “Decision”, and “Delete” in the present embodiment. “Up” is an instruction to switch the buttons B1 and B2 which are in an active state to the upper side. “Down” is an instruction to switch the buttons B1 and B2 which are in an active state to the lower side. “Right” is an instruction to switch the buttons B1 and B2 which are in an active state to the right side. “Left” is an instruction to switch the buttons B1 and B2 which are in an active state to the left side. In the present embodiment, the arrangement of respective instructions corresponds to the arrangement of the decision key 17 and the direction key 16 in the control device 10. Specifically, the “Right” surface is disposed on the right side of the “Decision” surface, the “Left” surface is disposed on the left side of the “Decision” surface, the “Up” surface is disposed on the upper side of the “Decision” surface, and the “Down” surface is disposed on the lower side of the “Decision” surface. The “Delete” surface is disposed on the back side of the “Decision” surface.

“Decision” is an instruction to execute functions set for the buttons B1 and B2 which are in an active state. That is, if a button which is in an active state is the [Store name] button B1, the input of the store name is received, and if a button which is in an active state is the [Details] button B2, detailed information on the corresponding store is displayed. “Delete” is an instruction to delete a store corresponding to the buttons B1 and B2 which are in an active state, from the candidate stores. Since the cubic switch SW is a regular hexahedron 3D image, some (for example, three) of the six surfaces are visible, and other surfaces are hidden behind.

In the interface area P2, as described above, since the nearby outside scene is transmitted and visible, the user extends the fingertip of the hand in the field of view so as to operate the cubic switch SW by using fingertip.

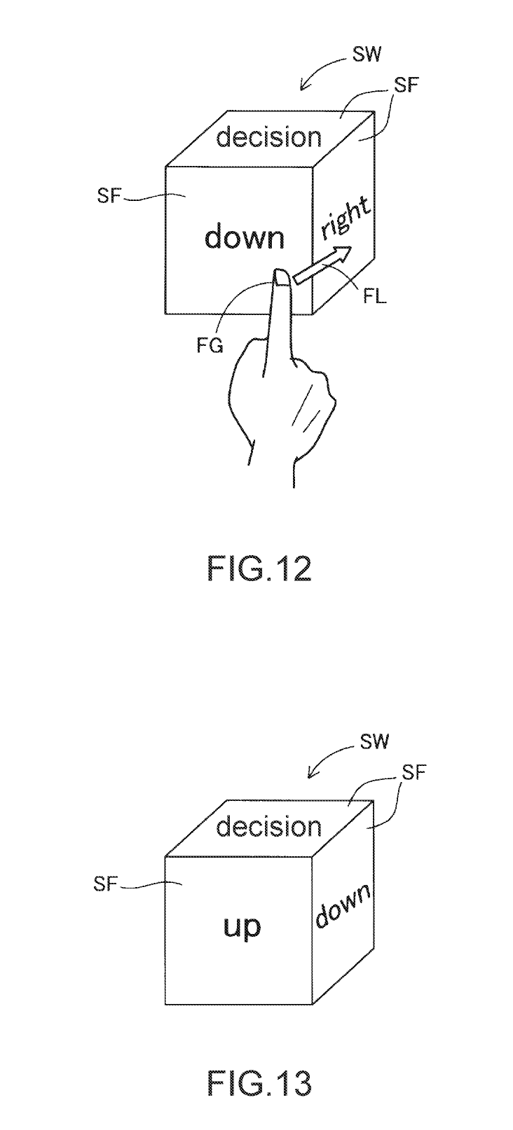

FIG. 12 is an explanatory diagram illustrating an example of the operation of rotating the cubic switch SW. The user of the HMD 100 hits (puts) a fingertip FG of the hand on one surface SF of the cubic switch SW as illustrated, and flicks (slides) as illustrated by an arrow FL, thereby rotating the cubic switch SW. In other words, it is possible to switch the orientation in which the cube as the cubic switch SW is displayed.

FIG. 13 is an explanatory diagram illustrating the cubic switch SW after rotation. As a result of operation as illustrated in FIG. 12, the cubic switch SW is switched to the state of FIG. 13, that is, to an orientation in which the surface marked as “Up” is displayed. Although the state of FIG. 13 is obtained by switching the surface SF in the flick direction by one surface from the state of FIG. 12, it is also possible to switch the surface SF by two or three surfaces by setting the flick distance longer, with respect to the cubic switch SW.

The front surface SF of the cubic switch SW can be tapped by the user. The “front surface” is the surface facing the user, and corresponds to the surface SF marked as “Up” in the example of FIG. 13. “Tap” is an operation to hit (put) the fingertip FG of the hand on the image element and move the fingertip FG forward (to the front side viewed from the user) so as to press it. If the front surface SF of the cubic switch SW is tapped, the HMD 100 is allowed to execute the instruction allocated to the front surface SF. In this embodiment, the surface other than the front surface SF has a configuration that cannot be tapped. The reason why only the front surface SF can be tapped is that a configuration in which the upper surface is to receive tapping is defined in advance in the application program.

For example, in the display state of the interface area P2 illustrated in FIG. 11, when tapping the front surface SF of the cubic switch SW, that is, the surface SF marked as “Down”, the button which is in an active state is switched from the [Store name] button B1 marked as “OO store” to the [Store name] button B1 marked as “ΔΔ store”.

For example, in the display state of the interface area P2 illustrated in FIG. 11, the surface SF marked as “Decision” is switched to the front side by flicking the cubic switch SW to the lower side, and then when tapping the front surface SF, “Decision” is executed on the [Store name] button B1 marked as “OO store” which is in an active state. Specifically, the control function unit 150 (FIG. 6) of the HMD 10 receives the store name such as “OO store”.

For example, in the display state of the interface area P2 illustrated in FIG. 11, the surface SF marked as “Right” is switched to the front side by flicking the cubic switch SW to the right side, and then when tapping the front surface SF, the button which is in an active state is switched from the [Store name] button B1 marked as “OO store” to the [Details] button B2 on the right side. Thereafter, the surface SF marked as “Decision” is switched to the front side by flicking the cubic switch SW to the lower side, and when tapping the front surface SF, “Decision” is executed on the [Details] button B2 of “OO store” which is in an active state. As a result, the detailed information on the corresponding store “OO store” is displayed in the interface area P2. The detailed information is based on the data in “Detailed description” of the data set received from a customer server in step S140 (see FIG. 10).

The description returns to the flowchart in FIG. 9. The operation using the cubic switch SW described above is realized by the process from steps S170 to S196.

In step S170, the main processor 140 controls the camera 61 so as to execute imaging, and detects the movement of the user's fingertip FG from the obtained imaging image. Next, the main processor 140 determines whether or not the above-described flick or tap operation is performed on the cubic switch SW, from the detected movement of the fingertip FG (step S180), and if the operation is not performed, the process returns to step S170 and the main processor 140 waits for an operation. In step S180, when an operation is determined to be performed on the cubic switch SW, it is determined whether the operation is a flick or a tap (step S190).

If it is determined that the operation is a flick in step S190, the main processor 140 switches the orientation in which the cubic switch SW is displayed based on the flick direction (step S192). That is, the cubic switch SW is changed into an image which is in a state of being rotated in the flicked direction. The process of steps S170 to S192 corresponds to the polyhedron orientation switching unit 155b (FIG. 6). After execution of step S192, the process returns to step S170, and the main processor 140 waits for the next operation of the user.

On the other hand, if it is determined that the operation is a tap in step S190, the main processor 140 executes the instruction allocated to the tapped surface (in this embodiment, the front surface, that is, the surface facing the user) SF (step S194). That is, in a case of “Up”, the buttons B1 and B2 which are in an active state are switched to the upper side. In a case of “Down”, the buttons B1 and B2 which are in an active state are switched to the lower side. In a case of “Right”, the buttons B1 and B2 which are in an active state to the right side. In a case of “Left”, the buttons B1 and B2 which are in an active state are switched to the left side. In a case of “Delete”, the store corresponding to the buttons B1 and B2 which are in an active state is deleted from the candidate stores.

If it is determined to be “Decision”, it is split into two operations. When the button which is in an active state is the [Store name] button B1, the identification information of the corresponding store, that is, the store name is input. Specifically, when the button which is in an active state and receives the store name of “OO store” is the [Details] button B2, the store input processor 155 of the control function unit 150 (FIG. 6) of the HMD 10 displays the detailed information on the corresponding store is displayed. The detailed information is based on the data in “Detailed description” of the data set received from a customer server in step S140 (see FIG. 10). In the present embodiment, the detailed information is displayed in the interface area P2 only for a predetermined time (for example, five seconds), and the interface area P2 returns to the original display after five seconds. The process of steps S170 to S190 and S194 corresponds to the instruction execution unit 155c (FIG. 6).

After execution of step S194, the main processor 140 determines whether or not the button which is in an active state is the [Store name] button B1, and the instruction allocated to the tapped surface SF is “Decision” (step S196). Here, in a case of negative determination, that is, when the button which is in an active state is the [Details] button B2, or the instruction allocated to the tapped surface SF is an instruction other than “Decision”, the processor returns to the process of step S170, and waits for the next operation of the user.

On the other hand, in a case of positive determination in step S196, in other words, when it is the [Store name] button B1 and “Decision”, the process proceeds to “End”, and completes the store input processing routine. In other words, in a case of positive determination, since acceptance of input of a store name is completed by the process of step S194, the store input processing routine is completed.

The main processor 140 sends the store name accepted by the store input processing routine to the store server 300 and displays the guide information sent from the store server 300, by executing another process, after the store input processing routine is completed.

### A-5. Effect of Embodiment

According to the HMD 100 of the first embodiment configured as described above, when designating one store among the plurality of stores included in the field of view that can be visually recognized through the right and left light guide plates 26 and 28, it is possible for the user to perform the designation, by flicking and rotating the cubic switch SW and tapping the front surface SF. Therefore, according to the HMD 100, the operability of the user can be improved. Particularly, according to the HMD 100, since the cubic switch SW is a regular hexahedron 3D image, it is possible to perform a process by an easy and intuitive operation. Accordingly, the operability can be further improved.

### B. Second Embodiment

The HMD in a second embodiment of the invention is different from the HMD 100 in the first embodiment in some functions realized by the control function unit 150 (FIG. 6). Specifically, a difference is in that a work support processor (not illustrated) is provided in the control function unit included in the HMD 100, instead of the store input processor 155 (FIG. 6) in the first embodiment. Since the remaining configuration of the HMD in the second embodiment is the same as in the first embodiment, a description thereof will be omitted.

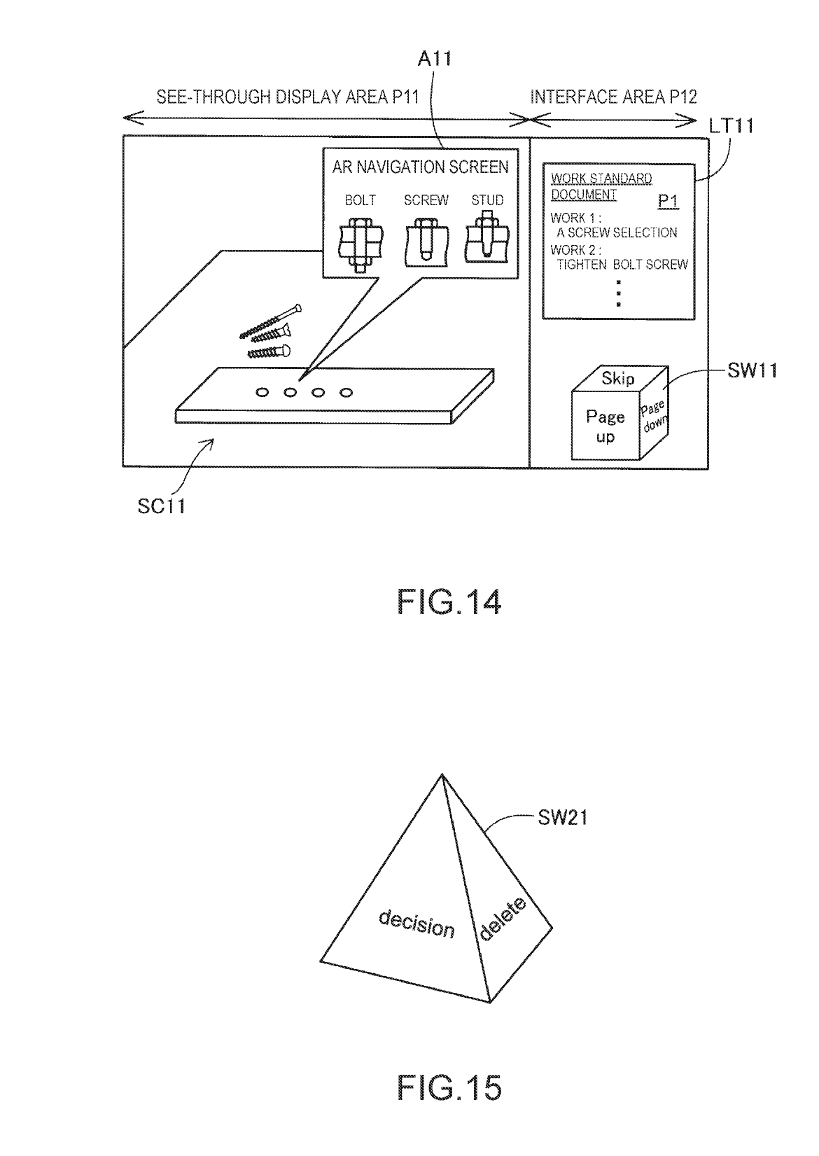

FIG. 14 is an explanatory diagram illustrating a see-through display area P11 and an interface area P12, which are generated by the work support processor of the second embodiment. A speech bubble A11 which is an AR image is displayed in the see-through display area P11 so as to be superimposed on outside scene SC that is viewed in a see-through manner, similar to the see-through display area P1 (FIG. 11) of the first embodiment. A screw and a plate material for performing screw fixing are included in the outside scene SC11. The speech bubble A11 includes an AR navigation screen for performing work instructions.

A work standard document LT11 illustrating a procedure of a work is displayed in the interface area P12. The worker reads the work standard document LT11 displayed in the interface area P12, and performs the screwing operation, in accordance with an instruction by the AR navigation screen of the speech bubble A11. The work standard document LT11 corresponds to “image” according to the invention described in the Summary section.

The interface area P12 includes a cubic switch SW11, similar to the first embodiment. The cubic switch SW11 functions as a GUI for switching the display of the page of the work standard document LT11. “Page up”, “Page down”, “Work standard document enlargement”, “Work standard document reduction”, “AR navigation screen enlargement” and “AR navigation screen reduction” are allocated to the respective surfaces SF of a cube (regular hexahedron) constituting the cubic switch SW11.

“Page up” is an instruction to flip (send) one page of the work standard document LT11. “Page down” is an instruction to return one page of the work standard document LT11. “Work standard document enlargement” is an instruction to enlarge and display the work standard document LT11. “Work standard document reduction” is an instruction to reduce and display the work standard document LT11. The “AR navigation screen enlargement” is an instruction to enlarge the AR navigation screen displayed in the speech bubble A11. The “AR navigation screen reduction” is an instruction to reduce the AR navigation screen displayed in the speech bubble A11.

Similar to the cubic switch SW of the first embodiment, it is possible to rotate the cubic switch SW11, by hitting (putting) the fingertip FG of the hand on one surface SF of the cubic switch SW11 and flicking (sliding) the fingertip. If the front surface SF of the cubic switch SW is tapped, the HMD 100 is allowed to execute the instruction allocated to the front surface.

According to the HMD of the second embodiment configured as described above, page feed/page return/enlargement/reduction of the work standard document LT11 displayed in the interface area P12 can be performed by flicking to rotate the cubic switch SW11, and then tapping the front surface. Therefore, according to the HMD, the operability of the user can be improved. Particularly, according to the HMD, since the cubic switch SW11 is a regular hexahedron 3D image, it is possible to perform a process by an easy and intuitive operation. Accordingly, the operability can be further improved.

### C. Third Embodiment

The HMD in a third embodiment of the invention is different from the HMD 100 in the first embodiment in the configuration of the control device (controller), and the remaining constituent elements are the same as in the first embodiment. The same constituent elements are described by using the same reference numerals as in the first embodiment, below. The first embodiment is configured such that the cubic switch SW is rotated by flicking the displayed cubic switch SW with the fingertip. In contrast, in the third embodiment, it is possible to rotate the displayed cubic switch SW by using the control device (controller).

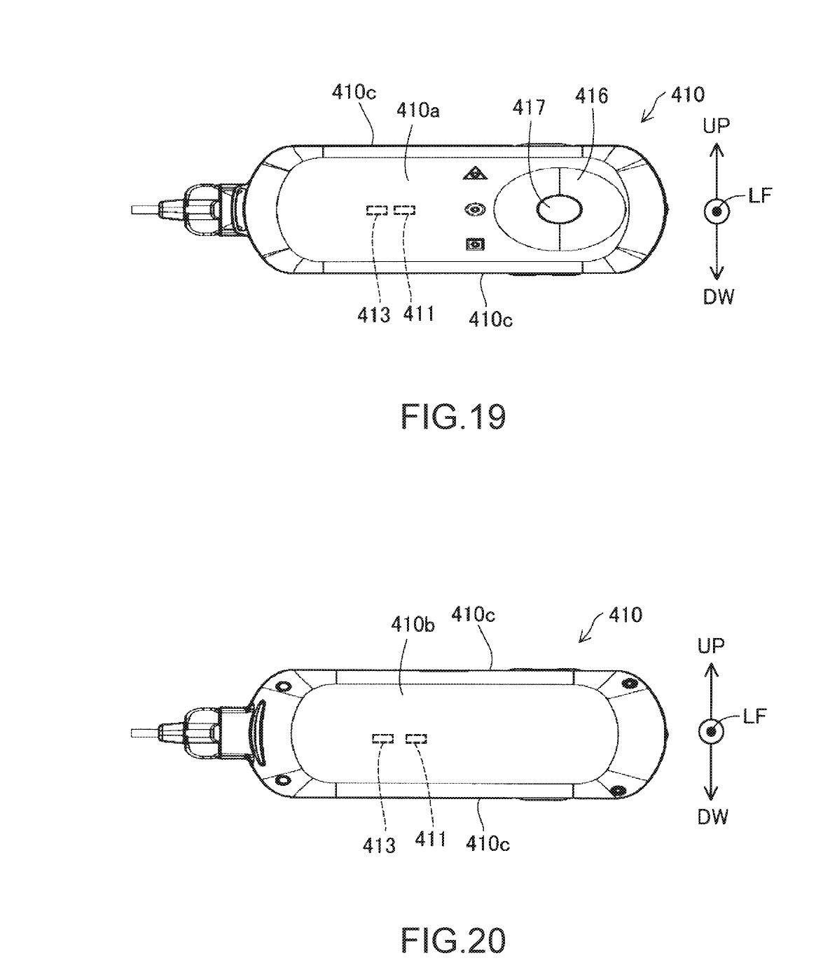

FIG. 18 is an explanatory diagram illustrating a control device (hereinafter, referred to as “controller”) 410 in the third embodiment. The controller 410 is an operation unit operated by the user, and has a plate shape including a front surface 410a, aback surface 410b, and side surfaces 410c on both sides. A direction key 416 (FIG. 19) and a decision key 417 (FIG. 19) are provided on the front surface 410a. The controller 410 is replaced to the control device 10 in the first embodiment, and has the same function as the control device 10.

In FIG. 18, “UP” is the upper side in the vertical direction, and “DW” is the lower side in the vertical direction. “LF” is the left direction. In the state of FIG. 18, the front surface 410a is the upper side in the vertical direction, that is, a surface facing upwards. The controller 410 is usually used with the front surface 410a facing upwards.

Similar to the control device (controller) 10 in the first embodiment, a six-axis sensor 411 and a magnetic sensor 413 are provided inside the controller 410. The orientation of the controller 410 can be specified, by combining the detection signal of the six-axis sensor 411 and the detection signal of the magnetic sensor 413.

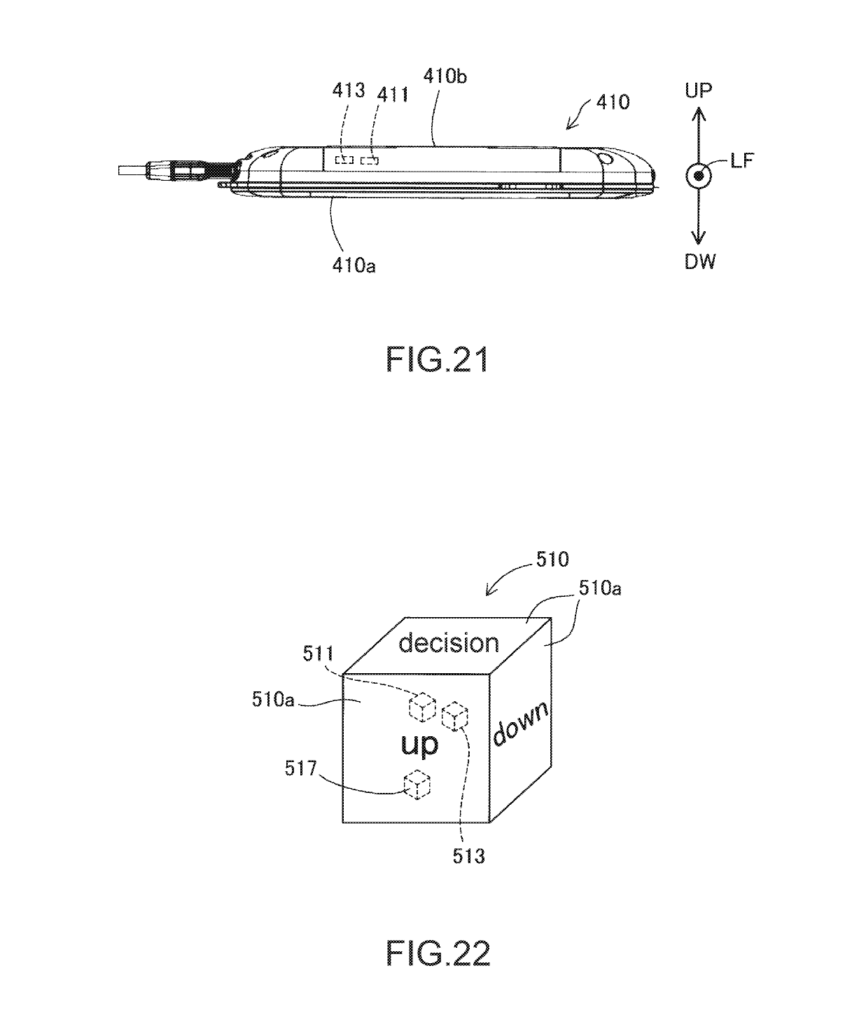

FIG. 19 is an explanatory diagram when the front surface 410a of the controller 410 is directed to the left side, FIG. 20 is an explanatory diagram when the front surface 410a of the controller 410 is directed to the right side, and FIG. 21 is an explanatory diagram when the front surface 410a of the controller 410 is directed downward in a vertical direction. FIG. 19 to FIG. 21 illustrate plan views seen from the left toward the right, similar to FIG. 18. The user can switch the front surface 410a of the controller 410 upward which is the state of FIG. 18, leftward which is the state of FIG. 19, rightward which is the state of FIG. 20, or downward which is the state of FIG. 21, respectively. The controller 410 can detect that the orientation of the front surface 410a of the controller 410 is switched, from the orientation of the controller 410 specified based on the detection signal of the six-axis sensor 411 and the detection signal of the magnetic sensor 413.

In this embodiment, setting the front surface 410a of the controller 410 upward is associated with the operation of flicking the cubic switch SW (FIG. 11) in the first embodiment to the upper side. Setting the front surface 410a of the controller 410 to leftward is associated with the operation of flicking the cubic switch SW in the first embodiment to the left side. Setting the front surface 410a of the controller 410 to the rightward is associated with the operation of flicking the cubic switch SW in the first embodiment to the right side. Setting the front surface 410a of the controller 410 to the downward is associated with the operation of flicking the cubic switch SW in the first embodiment to the lower side. As a result, the front surface 410a of the controller 410 is switched among upward, downward, leftward, and rightward, such that the orientation of the cubic switch SW displayed in the interface area P2 is switched.

In the present embodiment, the shaking of the controller 410 twice up and down is associated with the operation of tapping the front surface SF of the cubic switch SW in the first embodiment. As a result, when the controller 410 is shaken twice up and down, the instruction allocated to the front surface SF of the cubic switch SW is executed. The shaking of the controller 410 can be detected by the six-axis sensor 411 and the magnetic sensor 413.

When the orientation of the front surface 410a of the controller 410 is switched, the direction in which the orientation of the cubic switch SW is switched is determined by the application program as described above, but instead thereof, may be freely changeable by the user.

According to the HMD of the third embodiment configured as described above, when designating one store from among a plurality of stores included in the field of view, the user can perform the designation only by switching the orientation of the controller 410 and shaking the controller 410 twice up and down. Therefore, according to the HMD, similar to the HMD of the first embodiment, the user can perform a process by a simple and intuitive operation. In the third embodiment, the configuration including the controller 410 is applied to the first embodiment, but it may be applied to the second embodiment as another embodiment.

### D. Fourth Embodiment

The HMD in a fourth embodiment of the invention is different from the HMD 100 in the first embodiment in the configuration further including a second controller, and the remaining constituent elements are the same as in the first embodiment. The same constituent elements are described by using the same reference numerals as in the first embodiment, below.

FIG. 22 is a perspective view illustrating a second controller 510. The second controller 510 is an actual object having the same cubic (regular hexahedral) shape as the cubic switch SW displayed in the interface area P2 illustrated in FIG. 11. Respective instructions of “Up”, “Down”, “Right”, “Left”, “Decision”, and “Delete” are allocated to the respective surfaces 510a of the cube, similar to the cubic switch SW.

A six-axis sensor 511, a magnetic sensor 513, and a wireless communication unit 517 are provided inside the second controller 510. The six-axis sensor 511 is a motion sensor (inertial sensor) equipped with a three-axis acceleration sensor and a three-axis gyro (angular velocity) sensor. The magnetic sensor 513 is, for example, a three-axis geomagnetic sensor. The orientation of the second controller 510 can be specified, based on the detection signal of the six-axis sensor 511 and the detection signal of the magnetic sensor 513. The wireless communication unit 517 is configured with an antenna, an RF circuit, a baseband circuit, a communication control circuit, and the like, not illustrated, or is configured as a device in which these are integrated. The wireless communication unit 517 performs wireless communication conforming to the standards of a wireless LAN including, for example, Bluetooth (registered trademark), Wi-Fi (registered trademark), or the like with the control device (controller) 10.

The user rotates the second controller 510 by flicking the cubic switch SW with the fingertip, instead thereof. The second controller 510 sends the respective detection signals of the six-axis sensor 511 and the magnetic sensor 513 during rotation to the control device (controller) 10 through the wireless communication unit 517. The control device 10 specifies the rotation direction of the second controller 510 by combining the respective detection signals of the six-axis sensor 511 and the magnetic sensor 513 sent from the second controller 510, specifies the orientation of the image display unit 20 from the respective detection signals of the six-axis sensor 235 and the magnetic sensor 237, which are provided in the image display unit 20, and specifies the rotation direction of the second controller 510 with respect to the direction seen from the user, based on the rotation direction of the second controller 510 and the orientation of the image display unit 20 which are specified. Thereafter, the cubic switch SW displayed in the interface area P2 is rotated in synchronization with the specified rotation direction. As a result, the orientation of the cubic switch SW displayed in the interface area P2 is switched, by the user switching the orientation of the second controller 510.

The shaking of the second controller 510 twice up and down is associated with the operation of tapping the front surface SF of the cubic switch SW in the first embodiment. The shaking of the second controller 510 can be detected by the six-axis sensor 511 and the magnetic sensor 513. As a result, when the second controller 510 is shaken twice up and down, the instruction allocated to the front surface SF of the cubic switch SW is executed.

According to the HMD of the fourth embodiment configured as described above, when designating one store from among a plurality of stores included in the field of view, the user can perform the designation only by switching the orientation of the second controller 510 which is a real object, and shaking the controller 510 twice up and down. Therefore, according to the HMD, similar to the HMD of the first embodiment, the user can perform a process by a simple and intuitive operation. In the fourth embodiment, the configuration including the second controller 510 is applied to the first embodiment, but it may be applied to the second embodiment as another embodiment.

### E. Fifth Embodiment

The operation using the cubic switches SW and SW11 is a flick operation with the fingertip in the first and second examples, the operation of switching the orientation of the front surface 410a of the controller 410 in the third embodiment, and the operation of switching the orientation of the second controller 510 which is a real object in the fourth embodiment. In contrast, a fifth embodiment is configured such that the cubic switch SW is operated by using a wearable device.

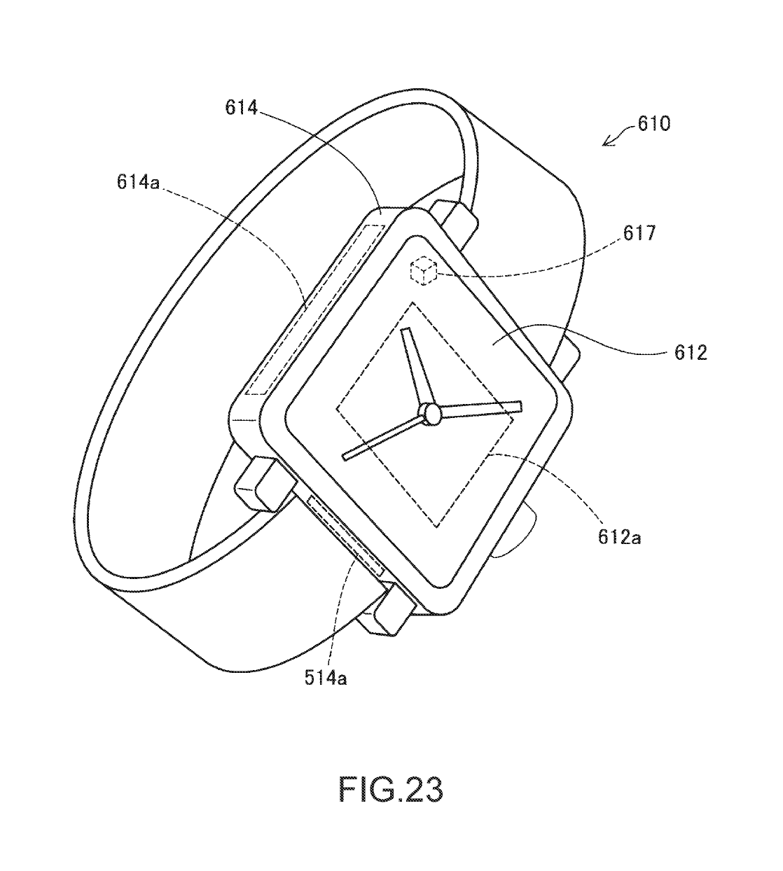

FIG. 23 is an explanatory diagram illustrating a watch-type device provided in an HMD of the fifth embodiment. The watch-type device 610 includes a face portion 612 and a case 614 for fixing the face portion 612. The face portion 612 includes a built-in clock hand, and a touch sensor 612a on a front surface thereof. The case 614 has a quadrangular shape, and includes a touch sensor 614a on each of the four side surfaces. The watch-type device 610 can accept an instruction to rotate the cubic switch SW by the touch sensor 614a provided on the side surface, and accepts an instruction of “Decision” by the touch sensor 612a provided on the front surface. The watch-type device 610 includes a wireless communication unit 617.

It is possible to improve the operability in the same manner as in the first embodiment and the second embodiment, by applying the watch-type device 610 having such a configuration to these embodiments. The wearable device is not limited to the watch-type device, and other types such as a wristband, a ring, and clothes may be used. In addition, as a modification example of the fifth embodiment, instead of a wearable device, a PDA, a mobile phone, or a smart phone may be used, and a touch sensor may be provided on four side surfaces and front surface thereof. In addition, another modification example of the fifth embodiment may be configured such that the orientation of the wearable device is specified, and the cubic switch SW is rotated in synchronism with the orientation of the specified wearable device.

### F. Modification Examples

The invention is not limited to the first to fifth embodiments and modification examples thereof, but can be implemented in various modes without departing from the gist thereof, and for example, the following modifications are possible.

### Modification Example 1

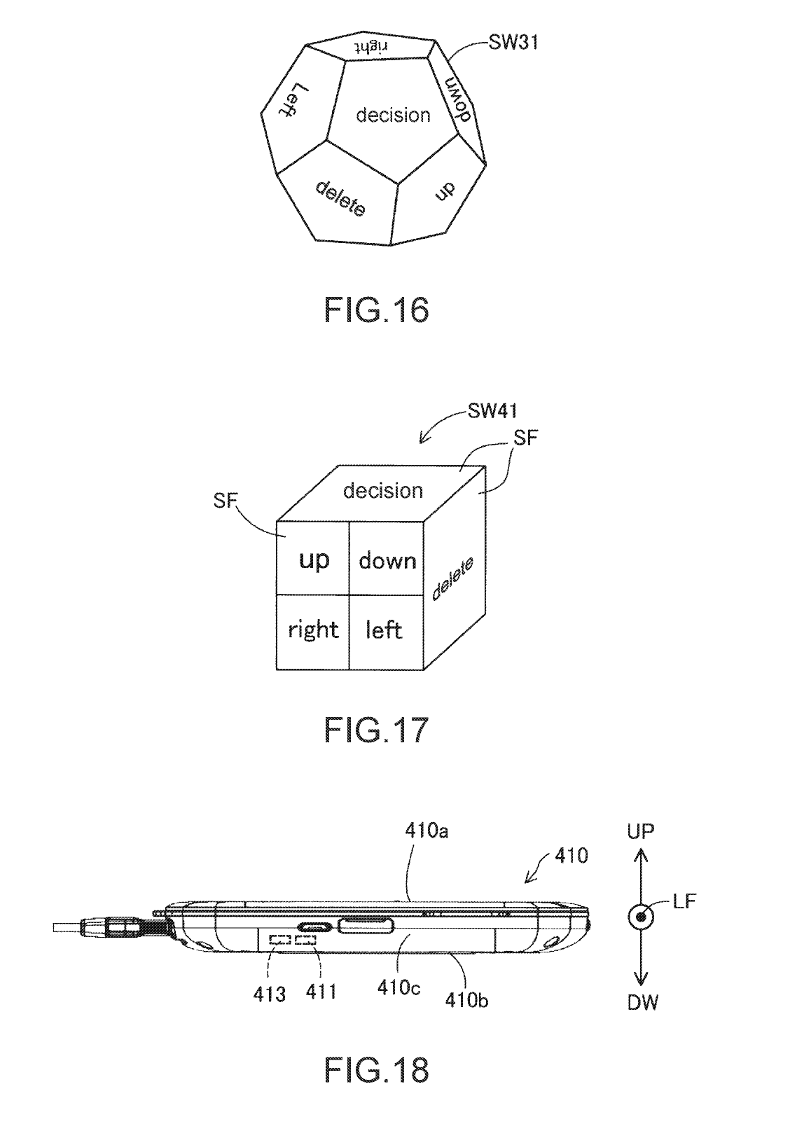

In each of embodiments and modification examples, the cubic switches SW and SW 11, to which an instruction is allocated to each surface, are cubic 3D images. On the other hand, as illustrated in FIG. 15, a switch SW21 to which an instruction is allocated to each surface may be a 3D regular tetrahedral image, or as illustrated in FIG. 16, a switch SW31 to which instructions are allocated to each surface may be a 3D regular dodecahedron image. That is, in a case of a 3D image of a polyhedron, the switch can be a 3D image having various numbers of equal sized surfaces. Further, the sizes of the surfaces are not necessarily equal to each other, but may be surfaces of different sizes. Further, instead of the 3D image, the switch may be configured to represent a polyhedron by a plurality of 2D images.

### Modification Example 2

Each of the embodiments and modification examples is configured such that the HMD 100 can execute the instruction allocated to the front surface, by tapping the surface (the front surface) facing the user of each of the cubic switches SW and SW11. On the other hand, a modification example may be configured such that the HMD 100 can execute the instruction allocated to the upper surface, by tapping the upper surface of each of the cubic switches SW and SW11. The upper surface is the surface marked as “Decision” in the example of FIG. 11. In short, as long as it is a surface in a predetermined orientation, it can be replaced with a surface in any orientation. Although a surface of a predetermined orientation is predefined by an application program, instead thereof, a surface in an orientation set by the user may be a predefined surface. Further, in each of the embodiments and modification examples, there is a single “a surface of a predetermined orientation”, but instead thereof, there may be a plurality of surfaces (for example, a front surface and an uppermost surface). These plurality of surfaces can be tapped, and the instruction allocated to the tapped surface is executed.

### Modification Example 3

Each of the embodiments and modification examples is configured such that the HMD 100 can execute the instruction allocated to the front surface, by tapping the surface (the front surface) facing the user of each of the cubic switches SW and SW11. On the other hand, a modification example may have a configuration in which the HMD 100 can execute an instruction allocated to the front surface, when the decision key 17 included in the control device 10 is pressed. Further, there is no need to be limited to the tap or the operation of the decision key 17, and it can be replaced with another operation by the user.

### Modification Example 4

Each of the embodiments and modification examples is configured such that the HMD 100 can execute the instruction allocated to the front surface, by tapping the surface (the front surface) facing the user of each of the cubic switches SW and SW11. On the other hand, a modification example may have a configuration in which the HMD 100 can execute the instruction allocated to the front surface, immediately without tapping, when switching the orientation of each of the cubic switches SW and SW11. According to this configuration, it is possible to further improve operability. Similar to Modification example 2, a configuration is possible in which an instruction allocated to a surface of another predetermined orientation such as the upper surface side is immediately executed, instead of the front surface.

### Modification Example 5

Each of embodiments and modification examples is configured such that an instruction is allocated to each surface of a cube forming each of the cubic switches SW and SW 11. On the other hand, as illustrated in FIG. 17, a cubic switch SW41 may be configured such that a plurality of (for example, four) instructions are allocated to a predetermined surface of a cube. The illustrated example is configured such that four instructions are allocated only to one surface of the cube, but instead thereof, a plurality of instructions may be allocated to all surfaces.

### Modification Example 6

Although the polyhedron image is set as a switch in each of the embodiments and modification examples, it is not necessarily a polyhedron image, and a stereoscopic image may be used. “Polyhedron” is a solid surrounded by a plurality (four or more) planes, does not include a solid having a curved surface, and is limited to a case where the boundaries of all surfaces are straight lines. On the other hand, as a modification example, solids other than polyhedrons may be set as a switch. That is, a solid may be a configuration in which a curved surface is included and an instruction is allocated to each surface or each region included in each surface, and such a solid may be a UI switch. Examples of solids other than polyhedrons include a cylinder, a cone, a ball, or the like.

### Modification Example 7

Although each of the embodiments and modification examples is configured such that the speech bubble is displayed on the see-through display areas P1 and P11 as an AR image, instead thereof, a configuration is possible in which the AR image is not displayed in the see-through display areas P1 and P11. Although each of the embodiments and modification examples is configured to include the see-through display areas P1 and P11 and the interface areas P2 and P12, instead thereof, a configuration may be possible in which only the see-through display areas P1 and P11 are included, and the list display field LT or the work standard document LT11, and cubic switches SW, SW11 are included in the see-through display areas P1 and P11. That is, the field of view visible through the right and left light guide plates 26 and 28 may be configured with only one area, or may be divided into a plurality of areas, and an AR image and an image of a solid (a polyhedron, or solids other than a polyhedron) may be displayed in any area thereof.

### Modification Example 8

In the configuration in which the cubic switch is provided in the see-through display area of Modification example 6, it may be configured such that the outside scene is easily viewed through the cubic switch. Specifically, the outside scene through the cubic switch may be easily viewed as well as the cubic switch, by changing the brightness and/or magnitude of the cubic switch, based on the brightness of the outside scene. Further, the cubic switch may be an image in which the whole is lightly colored and only the edges are enhanced.

### Modification Example 9

In the first embodiment, the cubic switch SW is used to designate one store from among a plurality of stores included in the field of view. In the second embodiment, the cubic switch SW11 is used to perform page feed/page return/enlargement/reduction of the work standard document LT11 displayed in the interface area P12. On the other hand, the cubic switch may be used to designate one item out of a plurality of items, and the cubic switch may be used to perform page feed/page return/enlargement/reduction of documents used for various support such as learning support and sports support. In addition, instructions on manufacturing, maintenance, or the like may be a support image. In short, the AR image can be anything as long as a switch of a solid (a polyhedron, or solids other than a polyhedron) is used to execute a process related to an AR image.

### Modification Example 10

In each of embodiments and modification examples, when receiving an operation on the cubic switches SW and SW 11, that is, when receiving an operation to rotate the cubic switches SW and SW11 and an operation to tap the front surface SF of cubic switches SW and SW11, vibration may be generated by the vibrator 19 with a predetermined vibration pattern. According to this modification example, it is possible to notify the user of the reception of the operation on the cubic switch by vibration. Therefore, the user can feel with the skin that the operation on the cubic switch is received, and the operability can be further improved.

### Modification Example 11

In each of embodiments and modification examples, apart of the configuration realized by hardware may be replaced with software, on the contrary, a part of the configuration realized by software may be replaced with hardware.

### Modification Example 12

In the above embodiments, the configuration of HMD is illustrated. However, the configuration of the HMD can be arbitrarily determined without departing from the gist of the invention, and for example, addition, deletion, conversion, or the like of the constituent elements can be made.

In the above embodiments, a description has been made about the so-called transmissive HMD 100 in which the right light guide plate 26 and the left light guide plate 28 transmit the external light. However, the invention can also be applied to, for example, a so-called non-transmissive HMD 100 in which an image is displayed without transmitting the outside scene. Further, an outside scene may be captured with a camera and the captured image may be displayed on the display unit, in the non-transmissive HMD 100. In these HMDs 100, in addition to augmented reality (AR) display for displaying images superimposed on the real space described above, mixed reality (MR) display in which the captured image of a real space and a virtual image are displayed in combination with each other, or virtual reality (VR) display for displaying a virtual space can be performed.

In the above embodiments, the functional units of the control device 10 and image display unit 20 are described, but they can be arbitrarily changed. For example, the following aspects may be adopted. An aspect in which the control device 10 is equipped with the storage function unit 122 and the control function unit 150, and the image display unit 20 is equipped with only a display function. An aspect in which the storage function unit 122 and the control function unit 150 are mounted on both the control device 10 and the image display unit 20. An aspect in which the control device 10 and the image display unit 20 are integrated. In this case, for example, the image display unit 20 includes all the components of the control device 10 and is configured as a glasses-type wearable computer. An aspect in which a smart phone or a portable game device is used instead of the control device 10. An aspect in which the control device 10 and the image display unit 20 are connected by wireless communication and the connection cable 40 is disposed. In this case, for example, power supply to the control device 10 and the image display unit 20 may also be performed wirelessly.

### Modification Example 13

In the above embodiments, the configuration of the control device is illustrated. However, the configuration of the control device can be arbitrarily determined without departing from the gist of the invention, and for example, addition, deletion, conversion, or the like of the constituent elements can be made.

In the above embodiments, an example of the input units included in the control device 10 is described. However, the control device 10 may be configured by omitting some input units exemplified, and includes other input units which are not described above. For example, the control device 10 may be equipped with an operation stick, a keyboard, a mouse, or the like. For example, the control device 10 may be equipped with an input unit that interprets a command associated with the movement of a user's body, or the like. For example, the movement of a user's body or the like can be obtained by line-of-sight detection for detecting a line of sight, gesture detection for detecting a movement of a hand, a foot switch for detecting a foot movement, or the like. The line-of-sight detection can be realized by, for example, a camera that takes an image of the inside of the image display unit 20. The gesture detection can be realized, for example, by analyzing the images taken with time by the camera 61.

In the above embodiments, the control function unit 150 is configured to operate by the main processor 140 executing the computer program in the storage function unit 122. However, the control function unit 150 can employ various configurations. For example, the computer program may be stored in the nonvolatile storage unit 121, the EEPROM 215, the memory 118, and other external storage devices (including a storage device such as a USB memory inserted in each of various interfaces, and an external device such as a server connected through a network), instead of the storage function unit 122, or together with the storage function unit 122. Each function of the control function unit 150 may be realized using an application specific integrated circuit (ASIC) designed to realize the function.

### Modification Example 14

In the above embodiments, the configuration of the image display unit is illustrated. However, the configuration of the image display unit can be arbitrarily determined without departing from the gist of the invention, and for example, addition, deletion, conversion, or the like of the constituent elements can be made.

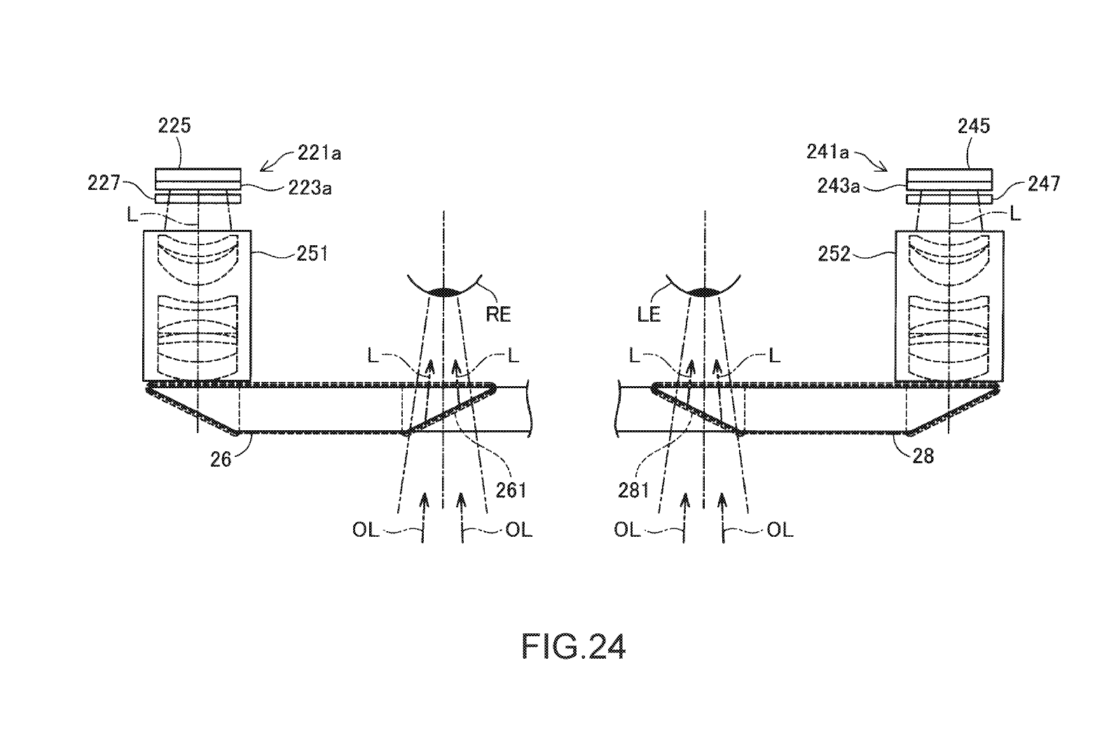

FIG. 24 is a plan view of a main part illustrating a configuration of an optical system included in an image display unit of a modification example. An OLED unit 221a corresponding to the user's right eye RE and an OLED unit 241a corresponding to the left eye LE are provided in the image display unit of the modification example. The OLED unit 221a corresponding to the right eye RE includes an OLED panel 223a emitting white color, an OLED drive circuit 225 driving the OLED panel 223a to emit light. A modulation element 227 (modulation device) is disposed between the OLED panel 223a and the right optical system 251. The modulation element 227 is formed of, for example, a transmissive liquid crystal panel, and modulates the light emitted by the OLED panel 223a to generate the image light L. The image light L that is modulated by passing through the modulation element 227 is guided to the right eye RE by the right light guide plate 26.

The OLED unit 241a corresponding to the left eye LE includes an OLED panel 243a emitting white color, an OLED drive circuit 245 driving the OLED panel 243a to emit light. A modulation element 247 (modulation device) is disposed between the OLED panel 243a and the left optical system 252. The modulation element 247 is formed of, for example, a transmissive liquid crystal panel, and modulates the light emitted by the OLED panel 243a to generate the image light L. The image light L that is modulated by passing through the modulation element 247 is guided to the left eye LE by the left light guide plate 28. The modulation elements 227 and 247 are connected to a liquid crystal driver circuit which is not illustrated. The liquid crystal driver circuit (modulation device driving unit) is mounted on, for example, a substrate disposed in the vicinity of the modulation elements 227 and 247.

According to the image display unit of the modification example, the right display unit 22 and the left display unit 24 are respectively configured with image elements including the OLED panels 223a and 243a as light source units, and the modulation elements 227 and 247 that modulate light emitted from the light source units to output image light including a plurality of color lights. The modulation device that modulates the light emitted from the OLED panels 223a and 243a is not limited to a configuration adopting a transmissive liquid crystal panel. For example, a reflective liquid crystal panel may be used, a digital micromirror device may be used, or a laser retinal projection type HMD 100 may be used, instead of the transmissive liquid crystal panel.

In the above embodiments, the glasses-type image display unit 20 has been described, but the aspect of the image display unit 20 can be arbitrarily changed. For example, the image display unit 20 may be worn like a hat, or may be incorporated in a body armor such as a helmet. Further, the image display unit 20 may be configured as a head up display (HUD) mounted on a vehicle such as an automobile or an airplane or other transportation means.

In the above embodiments, a configuration is exemplified in which a virtual image is formed by the half mirrors 261 and 281 on a part of the right light guide plate 26 and the left light guide plate 28, as an optical system that guides image light to the eye of the user. However, this configuration can be arbitrarily changed. For example, a virtual image may be formed in the area occupying the entire surface (or most portion) of the right light guide plate 26 and the left light guide plate 28. In this case, the image may be reduced by the operation of changing the display position of an image. In addition, the optical element according to the invention is not limited to the right light guide plate 26 and the left light guide plate 28 having the half mirrors 261 and 281, and an arbitrary aspect can be adopted as long as optical components by which image light is incident to the eye of the user (for example, a diffraction grating, a prism, a holography, or the like) is used.

The invention is not limited to the above-described embodiments, examples, and modification examples, and can be realized in various configurations without departing from the spirit thereof. For example, the technical features of the embodiments, examples, and modification examples corresponding to the technical features of each aspect described in the Summary section can be replaced or combined as appropriate, in order to solve some or all of the above-mentioned problems, or in order to achieve some or all of the aforementioned effects. Unless its technical features are described as essential herein, they can be deleted as appropriate.

The entire disclosure of Japanese Patent Application Nos. 2016-068133, filed Mar. 30, 2016 and 2016-205591, filed Oct. 20, 2016 are expressly incorporated by reference herein.

What is claimed is:

1. A head mounted display comprising:
a display unit that displays an image; and
a processor that executes a process,
wherein the processor includes
a polyhedron image display unit that displays a polyhedron image in which an instruction to instruct the process is allocated to each surface of the polyhedron, on the display unit,
a polyhedron orientation switching unit that receives an operation on the polyhedron image, and switches the orientation in which the polyhedron is displayed, and
an instruction execution unit that executes the instruction allocated to a surface of a predetermined orientation in the polyhedron image.

2. The head mounted display according to claim 1,
wherein the display unit is configured to allow an outside scene to be viewed, and
wherein the processor displays a related image related to the outside scene to be viewed, on the display unit, and executes a process based on the related image.

3. The head mounted display according to claim 2,
wherein the related image includes identification information for identifying a plurality of stores included in the outside scene to be viewed, and
wherein the process executed by the processor is a store input process for designating one store from the plurality of stores.

4. The head mounted display according to claim 2,
wherein the related image includes a support image for supporting a work related to the outside scene to be viewed, and
wherein the process executed by the processor is a process for sequentially switching the support image.

5. The head mounted display according to claim 1,
wherein the polyhedron image is a regular hexahedron 3D image, and
wherein the surface of the predetermined orientation is a surface facing a user.

6. The head mounted display according to claim 1,
wherein an operation on the polyhedron image is a flick operation with a fingertip.

7. The head mounted display according to claim 1, further comprising:
an operation unit provided with an input unit for receiving an input operation by a user on a first surface of a plurality of surfaces forming the outside,
wherein the polyhedron orientation switching unit
detects an operation of switching the orientation of the first surface in the operation unit, and
receives the detected operation of switching the orientation of the first surface as an operation on the polyhedron image.

8. The head mounted display according to claim 1, further comprising:
an object with a polyhedron shape corresponding to the polyhedron image,
wherein the polyhedron orientation switching unit
detects an operation of switching the orientation of the object, and
receives the detected operation of switching the orientation of the object as an operation on the polyhedron image.

9. The head mounted display according to claim 1, further comprising:
a vibration unit that vibrates when receiving the operation on the polyhedron image.

10. A head mounted display comprising:
a display unit that displays an image; and
a processor that executes a process,
wherein the processor includes
a stereoscopic image display unit that displays a stereoscopic image in which an instruction to instruct the process is allocated to each surface of a solid, on the display unit,
a solid orientation switching unit that receives an operation on the stereoscopic image, and switches the orientation in which the solid is displayed, and
an instruction execution unit that executes the instruction allocated to a surface of a predetermined orientation in the stereoscopic image.

11. A control method of a head mounted display including a display unit that displays an image, the control method comprising:
executing a process,
wherein the executing of a process includes
displaying a polyhedron image in which an instruction to instruct the process is allocated to each surface of the polyhedron, on the display unit,
receiving an operation on the polyhedron image, and switching the orientation in which the polyhedron is displayed, and
executing the instruction allocated to a surface of a predetermined orientation in the polyhedron image.

12. A computer program for controlling a head mounted display including a display unit that displays an image, the program causing a computer to realize a function of executing a process,
wherein the function of executing a process includes
a function of displaying a polyhedron image in which an instruction to instruct the process is allocated to each surface of the polyhedron, on the display unit,
a function of receiving an operation on the polyhedron image, and switching the orientation in which the polyhedron is displayed, and
a function of executing the instruction allocated to a surface of a predetermined orientation in the polyhedron image.

13. A computer program for controlling a head mounted display including a display unit that displays an image, the program causing a computer to realize a function of executing a process,
wherein the function of executing a process includes
a function of displaying a stereoscopic image in which an instruction to instruct the process is allocated to each surface of a solid, on the display unit,
a function of receiving an operation on the stereoscopic image, and switching the orientation in which the solid is displayed, and
a function of executing the instruction allocated to a surface of a predetermined orientation in the stereoscopic image.
